(19) United States
(12) Patent Application Publication
(10) Pub. No.: US 2023/0247504 A1
(43) Pub. Date: Aug. 3, 2023

(54) IAB LINK FAILURE

(71) Applicant: Fraunhofer-Gesellschaft zur Förderung der angewandten Forschung e.V., München (DE)

(72) Inventors: Thomas HAUSTEIN, Berlin (DE); Roya EBRAHIM REZAGAH, Berlin (DE); Thomas WIRTH, Berlin (DE); Jasmina MCMENAMY, Berlin (DE)

(21) Appl. No.: 18/296,508

(22) Filed: Apr. 6, 2023

Related U.S. Application Data
(63) Continuation of application No. PCT/EP2021/078705, filed on Oct. 15, 2021.

(30) Foreign Application Priority Data
Oct. 16, 2020 (EP) 20202361.0

(51) Int. Cl. H04W 36/08; H04W 76/19; H04W 60/06

(52) U.S. Cl. CPC H04W 36/08; H04W 76/19; H04W 60/06

(57) ABSTRACT

A network node configured for operating in a wireless communication network is configured or pre-configured with configuration instructions or is to receive configuration instructions, the configuration instructions related to an action that causes the network to disconnect from the wireless communication network. The network node is to receive, from the wireless communication network a trigger signal comprising information to perform the action and to perform the action based on the trigger signal. The configuration instructions further relate to one or more of a reconnection action to reconnect to the wireless communication network, a deregister action, e.g., an access barring, an initiation of a cell-search, a normal handover and/or a conditional handover.

### CROSS-REFERENCES TO RELATED APPLICATIONS

This application is a continuation of copending International Application No. PCT/EP2021/078705, filed Oct. 15, 2021, which is incorporated herein by reference in its entirety, and additionally claims priority from European Applications No. EP 20 202 361.0, filed Oct. 16, 2020, which is incorporated herein by reference in its entirety.

### BACKGROUND OF THE INVENTION

The present application concerns the field of wireless communication systems or networks, more specifically, the handling of backhaul radio link failure, RLF, for wireless communication networks such as integrated access and backhaul, IAB, networks. Embodiments of the present invention concern devices and methods related to handling wireless backhaul link-related issues—such as link degradations and such RLF.

FIG. 1 is a schematic representation of an example of a terrestrial wireless network 100 including, as is shown in FIG. 1(a), the core network 102 and one or more radio access networks RAN₁, RAN₂, . . . RAN_{N}. FIG. 1(b) is a schematic representation of an example of a radio access network RAND that may include one or more base stations gNB₁ to gNB₅, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RAND may include more or less such cells, and RAND may also include only one base station. FIG. 1(b) shows two users UE₁ and UE₂, also referred to as user equipment, UE, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1(b) shows two IoT devices 110₁ and 110₂ in cell 106₄, which may be stationary or mobile devices. The IoT device 110₁ accesses the wireless communication system via the base station gNB₄ to receive and transmit data as schematically represented by arrow 112₁. The IoT device 110₂ accesses the wireless communication system via the user UE₃ as is schematically represented by arrow 112₂. The respective base station gNB₁ to gNB₅ may be connected to the core network 102, e.g. via the S1 interface, via respective backhaul links 114₁ to 114₅, which are schematically represented in FIG. 1(b) by the arrows pointing to “core”. The core network 102 may be connected to one or more external networks. The external network may be the Internet, or a private network, such as an Intranet or any other type of campus networks, e.g. a private WiFi or 4G or 5G mobile communication system. Further, some or all of the respective base station gNB₁ to gNB₅ may be connected, e.g. via the S1 or X2 interface or the XN interface in NR, with each other via respective backhaul links 116₁ to 116₅, which are schematically represented in FIG. 1(b) by the arrows pointing to “gNBs”. A sidelink channel allows direct communication between UEs, also referred to as device-to-device, D2D, communication. The sidelink interface in 3GPP is named PC5.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, carrying for example a master information block, MIB, and one or more of a system information block, SIB, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. Note, the sidelink interface may a support 2-stage SCI. This refers to a first control region containing some parts of the SCI, and optionally, a second control region, which contains a second part of control information.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length. For example, in 5G a subframe has a duration of 1 ms, as in LTE. The subframe includes one or more slots, dependent on the subcarrier spacing. For example, at a subcarrier spacing of 15 kHz the subframe includes one slot, at a subcarrier spacing of 30 kHz the subframe includes two slots, at a subcarrier spacing of 60 kHz the subframe includes four slots, etc. Each slot may, in turn, include 12 or 14 OFDM symbols dependent on the cyclic prefix, CP, length.

The wireless communication system may be any single-tone or multicarrier system using frequency-division multiplexing, like the orthogonal frequency-division multiplexing, OFDM, system, the orthogonal frequency-division multiple access, OFDMA, system, or any other IFFT-based signal with or without CP, e.g. DFT-s-OFDM. Other waveforms, like non-orthogonal waveforms for multiple access, e.g. filter-bank multicarrier, FBMC, generalized frequency division multiplexing, GFDM, or universal filtered multi carrier, UFMC, may be used. The wireless communication system may operate, e.g., in accordance with the LTE-Advanced pro standard, or the 5G or NR, New Radio, standard, or the NR-U, New Radio Unlicensed, standard.

The wireless network or communication system depicted in FIG. 1 may be a heterogeneous network having distinct overlaid networks, e.g., a network of macro cells with each macro cell including a macro base station, like base station gNB₁ to gNB₅, and a network of small cell base stations, not shown in FIG. 1, like femto or pico base stations. In addition to the above described terrestrial wireless network also non-terrestrial wireless communication networks, NTN, exist including space borne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the 5G or NR, new radio, standard.

In mobile communication networks, for example in a network like that described above with reference to FIG. 1, like a LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. RSUs may have functionalities of BS or of UEs, depending on the specific network configuration. Other UEs may not be vehicular related UEs and may comprise any of the above-mentioned devices. Such devices may also communicate directly with each other, D2D communication, using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are not within one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station, e.g., GSM, UMTS, LTE base stations, that may not support certain service, like NR V2X services.

When considering two UEs directly communicating with each other over the sidelink, e.g., using the PC5/PC3 interface, one of the UEs may also be connected with a BS, and may relay information from the BS to the other UE via the sidelink interface and vice-versa. The relaying may be performed in the same frequency band, in-band-relay, or another frequency band, out-of-band relay, may be used. In the first case, communication on the Uu and on the sidelink may be decoupled using different time slots as in time division duplex, TDD, systems.

FIG. 2(a) is a schematic representation of an in-coverage scenario in which two UEs directly communicating with each other are both connected to a base station. The base station gNB has a coverage area that is schematically represented by the circle 150 which, basically, corresponds to the cell schematically represented in FIG. 1. The UEs directly communicating with each other include a first vehicle 152 and a second vehicle 154 both in the coverage area 150 of the base station gNB. Both vehicles 152, 154 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a Mode 1 configuration in NR V2X or as a Mode 3 configuration in LTE V2X.

FIG. 2(b) is a schematic representation of an out-of-coverage scenario in which the UEs directly communicating with each other are either not connected to a base station, although they may be physically within a cell of a wireless communication network, or some or all of the UEs directly communicating with each other are to a base station but the base station does not provide for the SL resource allocation configuration or assistance. Three vehicles 156, 158 and 160 are shown directly communicating with each other over a sidelink, e.g., using the PC5 interface. The scheduling and/or interference management of the V2V traffic is based on algorithms implemented between the vehicles. This configuration is also referred to as a Mode 2 configuration in NR V2X or as a Mode 4 configuration in LTE V2X. As mentioned above, the scenario in FIG. 2(b) which is the out-of-coverage scenario does not necessarily mean that the respective Mode 2 UEs in NR or mode 4 UEs in LTE are outside of the coverage 150 of a base station, rather, it means that the respective Mode 2 UEs in NR or mode 4 UEs in LTE are not served by a base station, are not connected to the base station of the coverage area, or are connected to the base station but receive no SL resource allocation configuration or assistance from the base station. Thus, there may be situations in which, within the coverage area 150 shown in FIG. 2(a), in addition to the NR Mode 1 or LTE Mode 3 UEs 152, 154 also NR Mode 2 or LTE mode 4 UEs 156, 158, 160 are present. In addition, FIG. 2(b), schematically illustrates an out of coverage UE using a relay to communicate with the network. For example, the UE 160 may communicate over the sidelink with UE₁ which, in turn, may be connected to the gNB via the Uu interface. Thus, UE₁ may relay information between the gNB and the UE 160.

Although FIG. 2(a) and FIG. 2(b) illustrate vehicular UEs, it is noted that the described in-coverage and out-of-coverage scenarios also apply for non-vehicular UEs. In other words, any UE, like a hand-held device, communicating directly with another UE using SL channels may be in-coverage and out-of-coverage.

It is noted that the information in the above section is only for enhancing the understanding of the background of the invention and, therefore, it may contain information that does not form conventional technology that is already known to a person of ordinary skill in the art.

Starting from the above, there may be a need for improvements or enhancements for providing user devices with additional control information.

### SUMMARY

An embodiment may have a network node configured for operating in a wireless communication network, wherein the network node is configured or pre-configured with configuration instructions or to receive configuration instructions, the configuration instructions related to an action that causes the network node to disconnect from the wireless communication network; wherein the network node is to receive, from the wireless communication network, a trigger signal comprising information to perform the action; and performing the action based on the trigger signal, wherein the action further relates to one or more of
a reconnection action to reconnect to the wireless communication network,
a deregister action, e.g., access barring;
an initiation of a cell-search;
a normal handover;
a conditional handover, CHO.

Another embodiment may have an access node configured for operating in a wireless communication network, the access node configured for providing a connection or proxy-access for a network node of the wireless communication network, the access node configured for: transmitting a trigger signal, to a network node, the trigger signal comprising information indicating that the network node is requested to perform an action that causes the network node to disconnect from the wireless communication network and for which the network node is configured or pre-configured; wherein the action relates to one or more of
a reconnection action to reconnect to the wireless communication network,
a deregister action, e.g., access barring;
an initiation of a cell-search;
a normal handover;
a conditional handover, CHO.

Another embodiment may have a wireless communication network, comprising at least one network node according to the invention; and at least one access node according to the invention.

### BRIEF DESCRIPTION OF THE DRAWINGS

Embodiments of the present invention will be detailed subsequently referring to the appended drawings, in which:

FIG. 1a and FIG. 1b are schematic representations of an example of a terrestrial wireless network, wherein FIG. 1(a) illustrates a core network and one or more radio access networks, and FIG. 1(b) is a schematic representation of an example of a radio access network RAN;

FIG. 2a and FIG. 2b are a schematic representation of in-coverage and out-of-coverage scenarios, wherein FIG. 2(a) is a schematic representation of an in-coverage scenario in which two UEs directly communicating with each other are both connected to a base station, and FIG. 2(b) is a schematic representation of an out-of-coverage scenario in which the UEs directly communicating with each other,

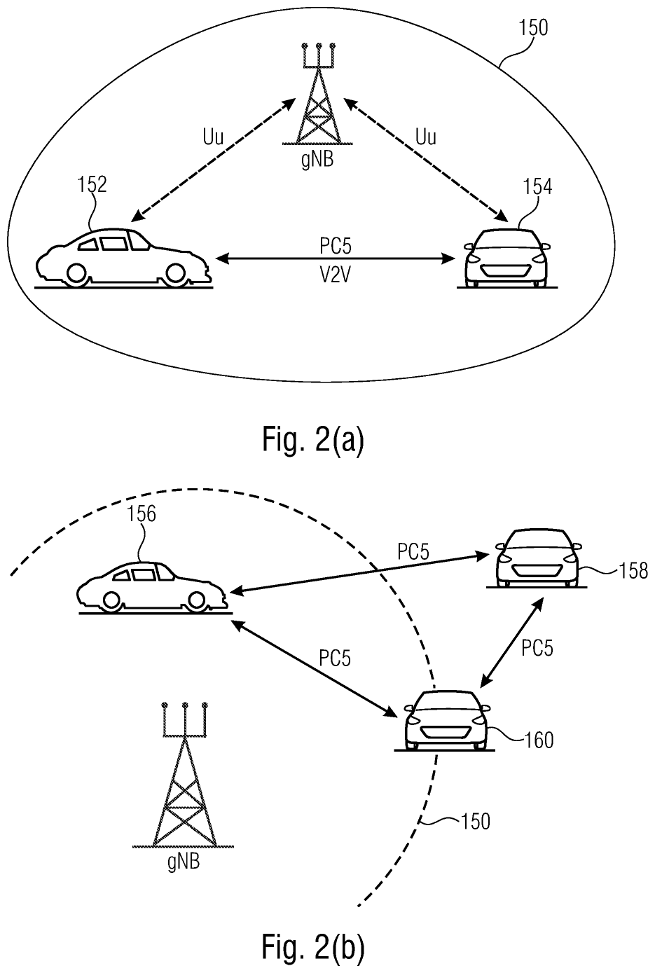

FIG. 3 is a schematic illustration of a centralized radio access network (C-RAN) with disaggregated base station being related to embodiments;

FIG. 4 is a schematic representation of a multi-hop IAB architecture being related to embodiments;

FIG. 5 is a schematic block diagram of a transmission chain according to an embodiment;

FIG. 6 is a schematic flow chart of a procedure being known as conditional handover, CHO;

FIG. 7 is an example diagram of a finite state machine showing states according to new radio, NR, underlying embodiments;

FIG. 8 is a schematic block diagram of a network node according to an embodiment;

FIG. 9 is a schematic block diagram of an access node according to an embodiment;

FIG. 10 is at least a part of a wireless communication network according to an embodiment comprising a campus network;

FIG. 11 is a schematic flow chart of a method according to an embodiment illustrating the triggered execution of the action by way of a backhaul link failure;

FIG. 12 is a schematic flow chart of a method according to an embodiment for informing idle UEs about the action to be performed by way of example for a conditional handover; and

FIG. 13 shows a schematic block diagram of a method being known for paging, forming a basis for embodiments.

### DETAILED DESCRIPTION OF THE INVENTION

Embodiments of the present invention are now described in more detail with reference to the accompanying drawings, in which the same or similar elements have the same reference signs assigned.

Some of the embodiments described herein are based on the finding that a radio link failure, RLF, in a backhaul network might cause severe issues at devices that try to communicate with each other or with other entities of the same or other networks by use of the backhaul network. Whilst the link to a serving node, e.g., an access node such as a distributed unit, DU, might show sufficient or even good conditions or parameters, a broken backhaul link may lead to a loss of service, or at least a large delay in communication or other issues. Those issues may be invisible or beyond the capability the communicating device may comprise to detect link failures. Embodiments provide for as solution for such failures.

Although the embodiments will be described in connection with base stations such as gNBs or eNBs as well as distributed units, DU, as a stationary node or a mobile node, e.g., in connection with a mobile terminal, MT, embodiments are not limited hereto. Embodiments apply, without any limitation, to any wireless communication network structures in which a network node, e.g., a vehicle, a user equipment, UE, or other entities wirelessly connect to an access node such as an integrated access and backhaul, IAB, node.

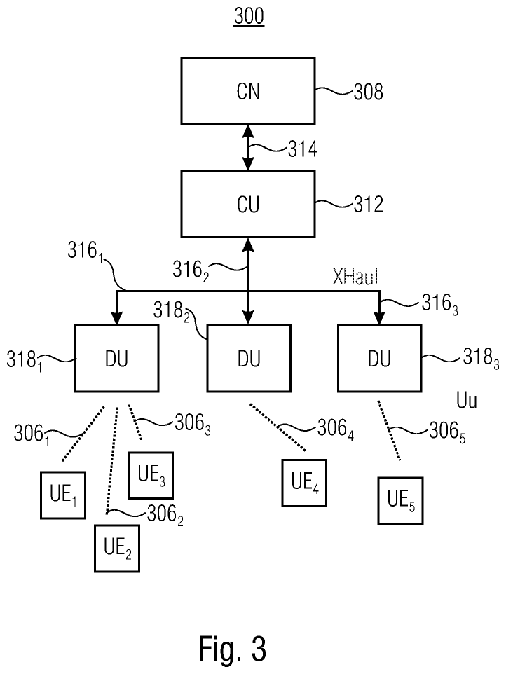

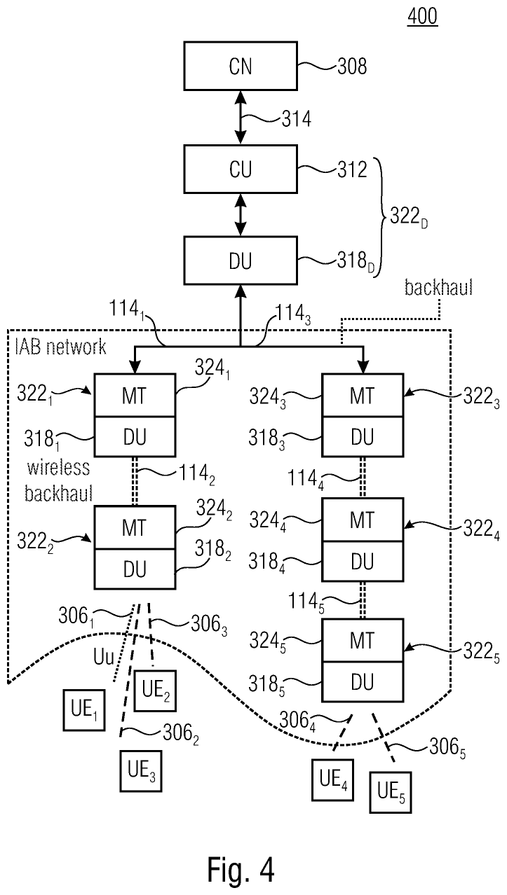

For illustrating examples of such networks, FIGS. 3 and 4 show schematic block diagrams of wireless communication networks 300, 400, respectively. Networks 300 and 400 comprise a core network, CN, 308 which is in communication with a central unit, CU, 312 via a respective link 314 which typically incorporate architecture wired links. The CU 312 may be, for example, CU 102 or base thereon. Whilst network 300 incorporates, for example, XHAUL links 316₁, 316₂ and 316₃ to distributed units, DU, 318₁ to 318₃ each being adapted to serve one or more UEs, UE₁ to UE₅ via wireless communication links or channels 306₁ to 306₅, e.g., using a Uu interface, wireless communication network 400 comprises a plurality of backhaul links 114₁ to 114₅ by which a plurality of integrated access and backhaul, IAB, nodes 322₁ to 322₅ communicate directly or indirectly with a donor base station 322_{D} comprising a DU 318_{D} and its CU 312. For example, IAB nodes 322₁ and 322₃ may communicate with the donor base station 322_{D} and its CU 312 directly using backhaul links 114₁ and 114₃. IAB node 322 may communicate indirectly with donor base station 322_{D} and its CU 312 and thereby with CN 308 by communicating with IAB node 322₁ being used as a relay. Although the backhaul link 1142 is implemented as a wireless backhaul link, it may also be implemented as a wired backhaul link. In a similar manner IAB node 322₅ indirectly communicates with CN 308 by communicating with IAB node 322₄ via backhaul link 114₅ so as to use IAB node 322₄ as a relay which itself uses IAB node 322₃ as a relay when communicating to IAB node 322₃ by use of backhaul link 114₄.

Although one or more UEs may also connect to DUs 318₁, 318₃ and/or 318₄, UEs UE₁ to UE₅ are shown so as to connect to DU 318₂, 318₅, respectively. Although each of the DUs 318₁ to 318₅ is shown so as to form the IAB node 322₁ to 322₅ together with a mobile terminal part, MT, 3241 to 3245, one or more DUs may also be implemented without a mobile terminal, e.g., using wired interfaces.

That is, FIGS. 3 and 4 show possible split architectures in cellular networks. A centralized radio access network (C-RAN) with split architecture/disaggregated base stations is illustrated in FIG. 3, a multi-hop IAB architecture is shown in FIG. 4. However, embodiments also relate to a combination of both.

In cellular wireless networks that feature split architectures with a central unit (CU) and distributed units (DUs), the backhaul network between CU and DUs is in general kept transparent to the UE. It is assumed that there is no performance loss for UEs attached to an access network (AN) using a split architecture when compared to UEs with direct connectivity to a base station (BS) attached to a core network (CN) using a flat architecture. A flat architecture implies that the BS is directly connected to a CN without any other RAN hops in between.

Split architectures can be deployed in centralized RAN (C-RAN), where a part of the signal processing is carried out in a CU, and another part is carried out in one or more DUs. Another deployment option is a backhaul network that uses Integrated Access & Backhaul (IAB) nodes. Here, IAB-nodes are connected to a donor base station that houses DU and CU. Furthermore, an IAB node consists of a mobile terminal (MT) part, as well as a DU part. The MT connects to a DU, whereas the DU consists of a base station part which can assign radio resources to MTs or UEs. A XHaul link can be interpreted as a backhaul or fronthaul link. A backhaul link could be implemented using a wireless backhaul technology. For example in NR, this could be implemented using a cm/mmWave NR link.

A DU typically houses PHY, MAC and RLC layer, while the layers PDCP and above are located in the CU. This means that control plane, i.e. the radio resource control (RRC) functions are located in the CU (see, [1]). In this case, the RRC messages between the gNB and UE are transferred through the interface between the CU and DU, using RRC message transfer procedures over F1AP interface ([2]). On the user plane, the upper layers of the protocol stack of the, i.e. PDCP and SDAP, are also located in the CU.

From a radio link perspective, the UE only sees the communication link between itself and the access part of the node, e.g. BS, gNB, DU. If an issue like a radio link failure (RLF) occurs on the backhaul network and if the direct link on the access side, e.g. Uu, between the UE and DU is operating as expected, the UE is unaware of this issue (at least for a period of time) and may experience some service degradation. Namely, the lower layer protocol mechanisms such as HARQ and RLC retransmissions (for the acknowledged mode) on the Uu interface are not applicable and therefore, cannot detect, correct or indicate this issue. Furthermore, on MAC layer, there is the datalnactivityTimer, used to monitor data and control signaling activity and enables the MAC layer to inform RRC when sufficient inactivity has been detected. Upon receiving the expiry of datalnactivityTimer from lower layers while in RRC_CONNECTED mode, the UE goes to IDLE state, with release cause ‘RRC connection failure’. Such a timer, however, does not solve the issue as in case above, the UE is not inactive and may still send or try to reconnect to a DU. Also, it may receive data, which is still in the DUs transmit buffer.

On the upper layer of the protocol stack (PDCP), the Downlink Data Delivery Service Status (DDDS) mechanism is designed to tackle flow control and short-term congestion on the link between CU and DU—but only on the downlink and for user plane data.

IAB introduces a multi-hop backhaul network with a number of hops between access base station and central base station. IAB nodes are expected to be deployed in a higher frequency range, e.g. FR2 or mmWave spectrum. Namely, for fixed wireless backhaul, operating in higher frequencies is more reasonable, since they do not interfere with “normal” cells. Although current 3GPP standard on IAB networks does not specify the limit on the number of hops, it is expected that most deployments will not feature more than a several hops. Nevertheless, the issue on the backhaul network with multiple hops can be more severe as the communication between CU and DU depends on the availability and reliability of each of the links. For example, a link failure on one of the hops in the backhaul network, where a backhaul node (e.g. an IAB node) does not have a backup connectivity to the CU—directly or via another node, means that UEs that are themselves not dual-connected to RAN, cannot reach CU and core network. In NR Release 16, an IAB node with a single link to an upstream node upon RLF needs to perform RRC Reconfiguration Reestablishment, which involves first trying to recover the link to the same parent node. If that fails, the node attempts to recover using an alternative parent node. If this procedure fails, the node transmits a recovery failure indication to the downstream, child nodes that only then begin to search for alternative parents. Delays at each stage add up resulting in potentially significant delays at the UEs.

Hence, the interruption for all the UEs that have only a single path that utilizes the failed link to the CU will continue until either the affected IAB node has its link recovered or until affected UEs reconnect to another access node. Mobile IAB nodes, which are not part of this 3GPP Release but are expected to be included in the standardisation in future, may complicate this issue even further.

The result of the above-described scenario is that the UE would be connected to an Access Node (AN), which does not have connectivity to a core network (CN). Although any higher layer timers would eventually expire, the probability is high that the same UE would try to reconnect to the same AN, since this AN might still provide the UE with the strongest downlink signal. For stationary UEs that are in idle mode, although the issue is not as pronounced, they would still camp on this AN, which does not have connectivity to a core network (CN). To establish connection, some of these UEs would try to connect to the same AN, since this AN may still provide them with the strongest downlink signal.

This scenario is similar to a scenario where small cells are deployed in airplanes, providing the strongest downlink signal within the airplane and forcing UEs to handover from the “outer cell”, which is the cellular network outside the airplane, to the “inner cell”, which is the cell spanned by the before-mentioned small cell.

While the network may resolve the above issues through a variety of mechanisms without prompting the UE, for mission critical services or services requiring URLLC or in some other cases, it would be beneficial to have the option to inform the UE from the AN-side directly or indirectly, so that the given UE can select a different gNB which still has a functioning backhaul connection. In this way, the services running on the UE could suffer less from delays and jitter, or even packet loss or reconnection delays. Furthermore, the UE would not have to wait for a timeout before performing a PRACH to a different cell.

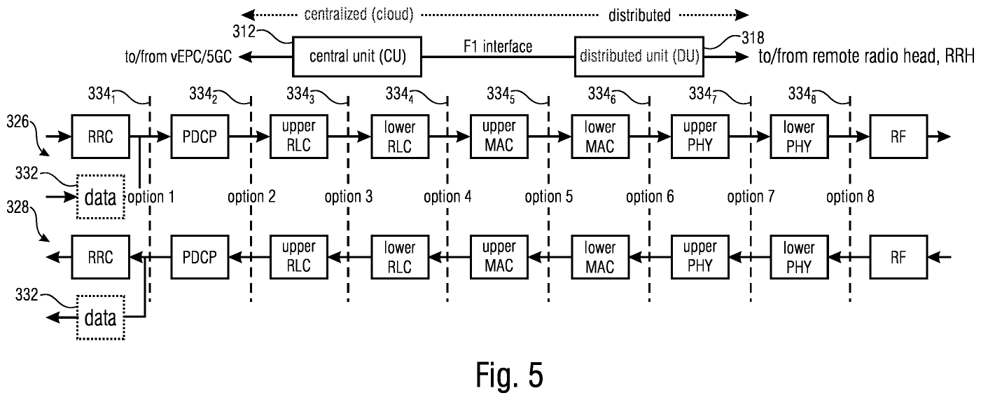

FIG. 5 shows a schematic block diagram illustrating functional blocks relating to radio resource control, RRC, packet data convergence protocol, PDCP, upper radio link control, RLC, lower RLC, upper medium access control, MAC, lower MAC, upper physical layer, PHY, lower PHY and radio frequency, RF. In FIG. 5, a transmission chain 326 and a reception chain 328 is shown by which data 332 may be transmitted or received. Options 1 to 8 show different distributions of the blocks to the CU 312 and the DU 318. Blocks shown on a left hand side of an associated segmentation line 3341 to 3348 being associated with the respective option is allocated at the CU 312 whilst functional blocks on a respective right hand side are arranged at the DU 318.

Thus, an implementation of a CU 312 and a DU 318 in embodied networks may vary.

In other words, FIG. 5 shows the possible functional splits between CU and DU. The radio resource control (RRC) sublayer is located within the CU. This terminates the RRC sublayer towards the UE. Thus, if the link between the CU and DU is broken, the RRC sublayer cannot carry out its typical functions, which include handover decisions based on neighbor cell measurement reported by the UE; controlling of UE measurements and reporting functions such as the periodicity of channel quality indicator reports; allocating cell-level temporary identifiers to active UEs; executing transfer of UE context from the serving gNB to the target-gNB during handover; performing integrity protection of RRC messages, and setting up and maintenance of radio bearers.

FIG. 5 thus, shows some or all entities involved in an access network, e.g., gNB, UE, core network, IAB (DU, MT), C-RAN (CU/DU), etc., and shows a functional split between CU and DU.

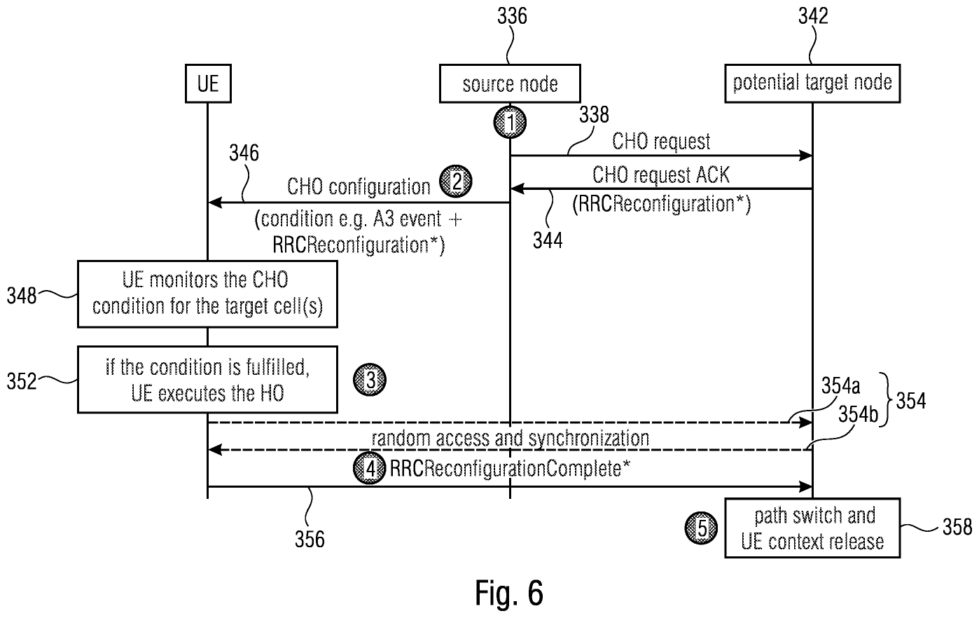

FIG. 6 shows a schematic flow chart of a procedure being known as conditional handover, CHO. A source node 336 transmits a CHO request message to a potential target node 342, thereby informing the potential target node about the possible handover. This request is acknowledged by a CHO request ACK 344 which may be transmitted, e.g., by use of RRC reconfiguration. The conditional handover configuration may be transmitted to a UE being subject to the CHO by use of a CHO configuration signal 346, thereby transmitting, e.g., a condition to be met, e.g., an A3 event, wherein the signal may further include the RRC reconfiguration. The UE monitors the CHO condition for the target cell or the target cells, 348 if the condition is determined to be met by the UE at 352, the UE executes the handover by performing a random access and synchronization procedure that incorporates transmission of uplink signals 354a and/or reception of downlink signals 354b. At a later time the RRC Reconfiguration Complete 356 may be transmitted and path switch and UE context release 358 may be performed at the target node 342.

In other words, FIG. 6 shows an illustration of the CHO procedure. In Conditional Handover (CHO), the network configures the UE with the event(s) that will eventually trigger a handover (HO) procedure. This is done without the UE providing a measurement report to the BS and without the UE having to wait for the HO command. The CHO configuration includes the list of potential target cells, and may be based on the measurement results of the given UE. Hence, the UE does not apply the handover command, but stores it and applies is only when this condition is met. In CHO, the target BSs are also configured to accept the UE, e.g. they reserve the resources for the UE. The CHO preparation is, therefore, similar to regular handover, except that the candidate target cell/BS does not expect UE to access it immediately or it may not even access it at all.

When referring to the embodied solution of the underlying problem of a link failure in the backhaul network, it has to be noted that it may be difficult or even impossible to determine such a failure at the UE, at least, within a suitable amount of time which is needed in view of delay requirements, e.g., in ultra-reliable low latency communication, URLLC, such that a conditional handover is an inappropriate measure to address backhaul link failures.

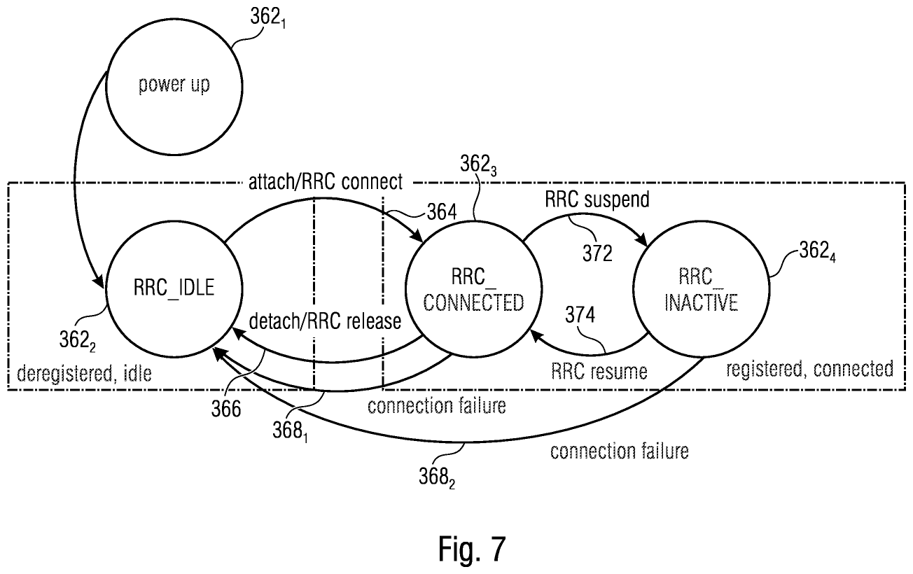

FIG. 7 shows an example diagram of a finite state machine showing states 362₁, 362₂, 362₃ and 362₄ according to new radio, NR, when defining states of a UE. A state 362₁, relating to a power up may lead to state 362₂ in which the UE is in RRC_IDLE, in which the UE is in idle mode or deregistered. By performing an attach-procedure 364 such as an RRC connect procedure, the UE may change to state 362₃ in which it is RRC_CONNECTED. A return from state 362₃ to state 362₂ is possible, for example, by performing a detach-procedure 366 such as an RRC release procedure. Further, a connection failure or link failure 368₁ may allow to return to state 362₂.

State 362₄, in which the UE is in RRC_INACTIVE mode, may be reached via RRC suspend 372, whilst a return is possible with RRC resume 374. In states 362₃ and 362₄ the UE is connected or registered to the network, the DU respectively. A connection failure 368₂ may allow to change from state 362₄ to state 362₂ in which the UE is deregistered and/or idle.

In other words, FIG. 7 illustrates the UE states of an NR UE. Compared to LTE, NR supports an additional state, the RRC_INACTIVE state, which is a part of the CM-CONNECTED state. Note that CM (Connection Management) is part of the 5G Core (5GC) and a UE within the CM-CONNECTED state means that the UE has signaling connection with the AMF.

In RRC_INACTIVE state, the CM directly forwards data/signaling to RAN without generating a paging request. RAN itself generates the paging message and performs paging to find the updated location of the UE, and then sends the data or signaling messages to the UE. The 5GC can transmit additional assistance information for RAN paging.

When referring again to the conditional handover procedure, CHO configuration 346 requires an RRC_CONNECTED state whilst it might be difficult or impossible to configure a UE for a CHO in states 362₂ or 362₄.

Concerning mechanisms through which the network may resolve backhaul RLF without prompting a UE to take action, this topic has been extensively discussed within 3GPP IAB Work Item. Below are the key aspects that are agreed for Release 16, relevant to this embodiment:
When the IAB-node is not configured with Dual Connectivity (DC), it applies for backhaul RLF handling the same mechanisms and procedures as UEs RLF handling currently specified in TS 38.331 (including e.g. detection and recovery).
For an IAB-node not configured with DC, it initiates RRC reestablishment when it receives downstream notification ‘Recovery Failure’.
RLF notification recovery failure would be triggered when RRC reestablishment has failed.
Upstream BH RLF notification to Donor CU via current F1-AP signalling is supported.
IAB-DU behaviour after RLF declaration is left up to implementation. IAB-DU should be able to send RLF notification when RLF recovery fails.

Furthermore, several notification types have been discussed for IAB backhaul RLF notification to downstream node(s):
Type 1—“Plain” notification: Indication that backhaul link RLF is detected by the IAB-node
Type 2—“Trying to recover”: Indication that backhaul link RLF is detected, and the IAB-node is attempting to recover from it
Type 3—“BH link recovered”: Indication that the backhaul link successfully recovers from RLF.
Type 4—“Recovery failure”: Indication that the backhaul link RLF recovery failure occurs.

From the perspective of this embodiment, current technical contributions discuss two topics of relevance:
1) Timing and type of notification (and behaviour of IAB-MT upon receiving the failure recovery notification)
   a. In [3], it is proposed that upon reception of the RLF notification, the downstream IAB node should forward the RLF notification to its child IAB node if it does not have a redundant route available. It is also proposed that upon the reception of the downlink RLF notification, the IAB node behaviour, such as forwarding the RLF notification or reselecting to another redundant path, could be left for network implementation.
   b. In [4], it is proposed that the trigger condition for transmitting the notification of recovery failure to downstream nodes should be specified. It is also proposed that either the expiry of the T311 or T301 timer can be considered as backhaul recovery failure event. The proposal is also to indicate that the cause of the RRC Reestablishment failure is a backhaul link failure.
   c. In [5], it is proposed that when the IAB node performs cell selection for re-establishment purpose, an intra-CU IAB node has priority over an Inter-CU IAB node. The serving CU configures Intra-CU node list to IAB node. IAB node can broadcast latency information e.g. the number of hops, for assisting cell selection (parent IAB node selection) during re-establishment.
   d. In [6], it is proposed that in order to avoid RRC re-establishment failure, the IAB node should firstly select the parent IAB node connected with the same donor CU to perform RRC re-establishment. It is suggested that IAB node sends an RLF notification to its child IAB node when it initiates the RRC re-establishment procedure. It is also proposed that the IAB node sends backhaul link recovered or Recovery failure notification to inform the RRC re-establishment result to the child IAB nodes. Further, the contribution proposes that when the IAB node receives RLF notification from its parent IAB node, it can forward this notification to its child IAB node if there is no redundant link to forward data for its child IAB-node and access UE.
   e. In [7], the authors observe that an IAB node should not choose as parent nodes or ancestor nodes the nodes that have experienced RLF or have received a recovery failure indication for connection reestablishment. Hence, they propose options for ensuring that IAB nodes and UEs do not choose nodes that have failed:
      i. The recovery failure indication also includes information about ancestor nodes that have failed.
      ii. A downstream indication of RLF at an IAB node in addition to an indication of RLF recovery failure.
2) Behaviour of the DU upon the IAB's node reception of RRC Reestablishment failure from a parent node.
a. In [8], two proposals pertain to the current embodiment: one that DU is shut down after MT's RRC connection re-establishment is failed, and the other one that DU broadcasts the indication of connection re-establishment for its accessing UEs relocation when MTs RRC connection re-establishment failure. Similarly, [9]proposes that a DU module shut down should not be precluded and that the DU shut down and the re-direct the anchored UEs should be left to implementation.
b. In [10], it is suggested that after BH RLF is detected at the IAB-MT, the IAB DU behaviour can be left up to implementation.
c. In [7], the authors propose that a failed IAB node modifies system information to bar access to the node.
d. In [11], the contribution points out that the UE may need to wait for a long period before RRC Reestablishment, if the serving cell fails its BH RLF recovery but continues to transmit SSB. It points out the need to consider solutions on how the UE is allowed to quickly avoid the current serving cell that fails BH RLF recovery, at least for Release16 UEs supporting e.g., industrial use cases. It also proposes an indication broadcasted in SIB1 to notify UEs about the backhaul recovery failure and to allow them to initiate RRC Reestablishment, MCG Failure Recovery and/or SCG Failure Recovery.

Embodiments provide for a modified conditional handover which may be referred to as enhanced CHO, eCHO. Embodiments incorporate the idea of an access node, AN, triggered gNB reselection for UEs with CHO configuration to arrive at an enhanced conditional handover, eCHO. When compared to a CHO, one of several differences may be that it is not required that the UE checks if the condition for executing the handover is met. It may be sufficient for a UE to receive a trigger signal, the trigger signal indicating that the condition is met. Further, the embodiments are not limited to a handover but also relate to other actions that causes the network to disconnect the UE from the wireless communication network. Also, handover (or any other reconfiguration command) for a UE may be stored/buffered in the access node AN. Based on a detection of an event by the access node, AN, e.g. RLF or upon receiving some trigger notification from a parent node, e.g. an RLF notification, the access node, AN can send the command to the UE. Optionally, the action may incorporate a re-connection. For example, the action may relate to a reconnection action to reconnect the UE to the wireless communication network, a deregister action, e.g., access barring, an initiation of a cell-search, a normal handover or a conditional handover.

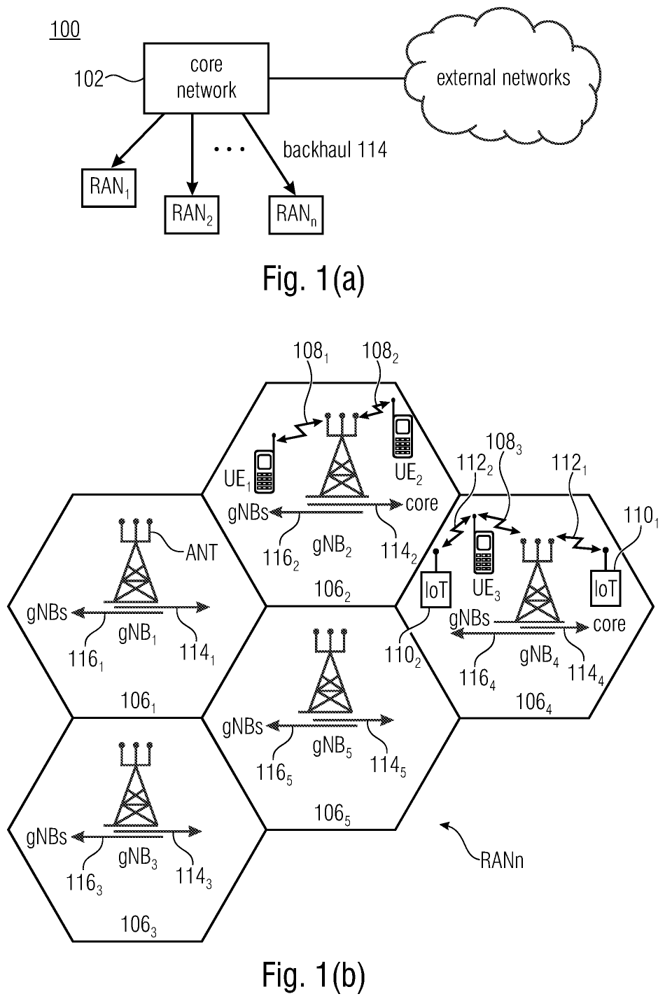

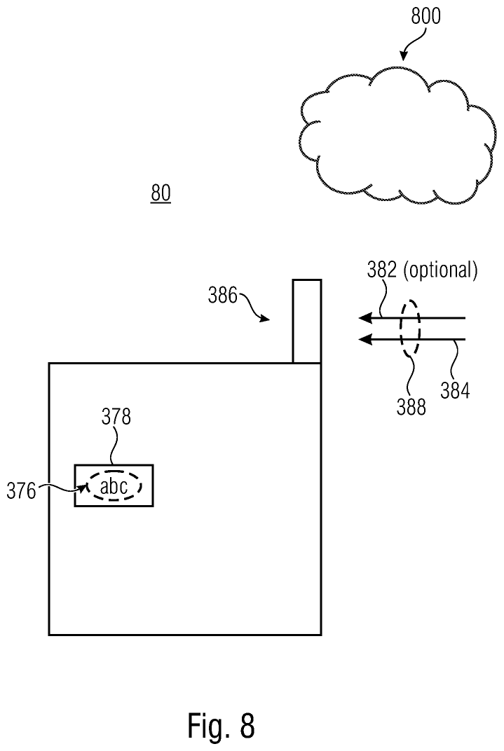

FIG. 8 shows a schematic block diagram of a network node 80 according to an embodiment. The network node 80 is configured for operating in a wireless communication network 800, e.g., the network of FIG. 1b, 2a, 2b, 300 and/or 400. The network node 80 may have access to configuration instructions 376. The configuration instructions 376 may be stored in a memory 378 which may incorporate a programmable memory and/or a one-time programmable memory. The configuration instructions 376 may be provided to the network node 80 by way of a pre-configuration, e.g., during a manufacturing process or an associated process and/or together with a subscriber identity module, SIM, or the like. Alternatively, the configuration instructions 376 may be received by the network node 80 with a configuration signal 382.

That is, the network node 80 may be configured or preconfigured with the configuration instructions 376 and/or may be adapted to receive configuration instructions 376, e.g., using the optional configuration signal 382. The configuration instructions 376 relate to an action that cause the network node 80 to disconnect from the wireless communication network 80. The network node 80 may receive, from the wireless communication network 800, a trigger signal 384. The trigger signal 384 comprises information to perform the action. When referring to the action to implement, at least in parts, a conditional handover, the trigger signal 384 may indicate, that the condition of the conditional handover is met.

Based on the trigger signal, i.e., based on the contained information, the network node 80 performs the action. The configuration instructions 376 further relate to one or more of
a reconnection action to reconnect to the wireless communication network 800;
a deregister action,
an access barring;
an initiation of a cell-search, e.g., to search for a different cell or a specific cell;
a normal handover; and/or
a conditional handover, CHO.

The trigger signal 384 may be received with a wireless interface 386, e.g., at least one antenna, at least one antenna panel or the like, which may also be received for receiving optional signal 382, wherein signal 382 may also be received with a different interface.

Implementing such a trigger signal allows to avoid a necessity that the UE has to determine the respective condition to be met. That is, the network node 80 may receive such information based on external measurements, which does not preclude to have the network node 80 to perform own measurements as supplementary information.

The network node 80 may be configured or pre-configured with a conditional handover, CHO, configuration as the action. For example, the action may be triggerable by the wireless communication network. In some embodiments, the action may be exclusively triggerable by the wireless communication network. That is, when compared to known conditional handovers, the wireless communication network decides when to perform the action and not the network node.

The CHO configuration may be configured in a firmware of the network node or may be hard-coded. This may allow for avoiding transmission of the configuration signal 382 for such configurations. However, the network node 80 may also receive the configuration instructions by use of the configuration signal 352. The network node 80 may be configured, pre-configured or may receive expiration information associated with the configuration instructions 376. The expiration information may be, for example, part of the configuration signal 382. The expiration information may indicate an expiration of the configuration instructions to operate according to the trigger signal only before or at the expiration of the configuration instructions. For example, the configuration instructions 376 relating to a search of a specific cell, to a conditional handover or a handover to a specific base station or access node or the like may be associated with an expiration data at which it is expected that the configuration is inappropriate. The network node 80 may delete the configuration instructions 376 after the expiration date or may keep them in the memory 378 or may copy them to a different memory. Using expiration information may be of particular advantage when having a network node being adapted to having access or configuration in accordance with multiple actions. For example, the network node 80 may have stored, by use of configuration, pre-configuration or at least one configuration signal, a plurality of configuration instructions, each configuration instruction relating to a specific action. For example, the respective configuration instructions may be identifiable by use of a specific identifier so as to allow explicitly distinguishing between the configuration instructions. Alternatively or in addition, the plurality of configuration instructions may each indicate a source of the trigger signal such that the respective action is associated with the source of the trigger signal which may be indicated in the trigger signal 384 itself. Thereby, different actions for different scenarios or events in the wireless communication network 800 may be stored in the network node 80. By using, optionally, expiration information, aged configurations may be dismissed, e.g., considering a movement of the network node to different cells such that the conditional handover might lead to improper targets.

Implementing a plurality of configuration instructions may incorporate some of the configuration instructions of the plurality to be included in the firmware or being hard-coded, e.g., in a SIM module or other circuits, and some of the plurality of configuration instructions to be received as a part of the configuration signal 382.

Actions to be indicated or instructed by use of the configuration signal 382 may thus relate to a scenario in which the network node 80 receives the configuration signal 382 and the trigger signal 384. This may relate to receive both signals 382 and 384 during two different instances of time or two messages that are uncorrelated in view of the resource allocation.

Alternatively, the configuration instructions contained in the configuration signal 382 and the trigger signal 384 may be received together as an execution signal 388 which may be a single message containing both information and/or may be a number of at least two separate messages. One implementation does not exclude a configuration of the network node 80 for the other implementation. For example, some instructions 376 may be received with a respective configuration signal being followed by an associated trigger signal 384 during some later instance of time whilst other instructions are received as an execution signal 388 whilst other actions may be stored in the network node 80 without an instruction signal such that only an associated trigger signal 384 is received. In some embodiments, the network node 80 may receive the configuration signal 382 and the trigger signal 384 as two separate messages but, nevertheless, simultaneously. Simultaneously may relate to at least one of
within a same radio frame;
within two or up to n consecutive radio frames, wherein n is a threshold;
within a timer period used for handover;
within one or up to n subframes, where n is a threshold;
within a predefined time interval of, e.g., at least 100 milliseconds and at most 1 second, i.e., a time interval in which the second message is expected;
within a number of m transmission or retransmission attempts, wherein m may be a threshold;
within a number of k connection establish or re-establish attempts;
within two or more parallel frequencies/links, e.g., via primary cell and a secondary cell e.g., as in carrier aggregation (CA);
within two or more frequencies/connections to different access nodes, in dual connectivity, e.g., multi radio-dual connectivity, MR-DC;
within two or more radio access technologies, RATs, e.g., LTE and 5G space new radio, NR, or non-3GPP and 3GPP, e.g., 5G NR and WiFi.

When referring to the mentioned timer period, for example, this can be a T300 timer, which the UE starts after transmission of the RRC Setup Request and which stops if the RRC setup was successful or when receiving an RRC reject message. Other timers, e.g., establish-timers, can be applied similarly, e.g., a T301 timer, a T311 timer and/or a T319 timer. Other times of the 3GPP specification may also be implemented, e.g., timers RRC protocol specification [12].

It is further to be noted that, especially in view of a simultaneous transmission, the trigger signal may also be received at the network node 80 prior, within the given definition of simultaneous, to receiving the instructions. Alternatively or in addition, both receptions may overlap in time at least in parts.

This may allow to immediately, or with a short or predetermined delay, cause the action. The network node may be configured for performing the action directly after having received the execution signal or the trigger signal; for performing the action within a predefined delay after having received the execution signal or the trigger signal; or performing the action based on an execution and/or time preference of the network node after having received the execution signal or the trigger signal, e.g., in accordance with the configuration instructions; and/or for performing the action based on a further trigger condition and/or a further status within the network node. This further trigger condition and/or further status may be observed or determined by the network node itself and/or by other nodes or the wireless communication network. For example, if the backhaul link breaks and the network node receives a trigger condition, the network node may be adapted to only perform its CHO (action) if it has data to transmit, if its battery level is above a certain threshold and/or if its channel condition has a certain quality and/or other criteria.

That is, the action may relate to an immediate or action or an action in the near future. Alternatively or in addition, at least one instruction may relate to an action which is performed later, i.e., the network node may be configured for receiving the configuration instructions during a first instance of time, e.g., with or without configuration signal 382, and for preparing the action, e.g., a conditional handover. The network node may be configured for receiving the trigger signal 384 during a later, second instance of time in which, for example, the radio resource control is unrelated to the first instance of time.

As described in connection with the simultaneous reception of instructions and trigger, also when receiving the trigger signal during a later, second instance of time, the network node may be configured for performing the action directly after having received the trigger signal 384;

or
performing the action with a predefined delay after having received the trigger signal; or
performing the action based on execution and/or time preference of the network node after having received the trigger signal, e.g., in accordance with the configuration instructions; or
performing the action based on a further trigger condition and/or a further status within the network node, i.e., a requirement of the network node to transmit the data, a battery level being at least a predefined threshold or above it and/or the network node to use a channel if its channel quality is at least a predefined channel quality.

The configuration instructions may indicate a designated access node and/or a group of access nodes of the wireless communication network 800 to which the network node is requested to connect. The network node 80 may be configured for connecting to the designated access node or at least one of the group of access nodes when performing the action, e.g., responsive to receiving the trigger signal 384.

The configuration instructions 376 may indicate a designated access node of the wireless communication network to which the network node is requested to connect. The network node 80 may deviate from this request and may select a new, other or different access node. Such a selection may be based on side information. Such side information may comprise one or more of:
According to or at least based on a further configuration of the network node or a measurement being made by the network node. For example, the configuration or measurement may reveal the requested access node so as to be improper or invalid such that the network node selects a different access node.
   One or more new potential access nodes may be chosen for or by an access node or by the network node, e.g., indicated as part of a prior or latest measurement report of the network node or of a node from which such a report is received. That is, measurements may reveal other network nodes so as to be a better choice for the action, e.g., a CHO, such that the network node 80 may deviate from the request.
In case of the action comprising a handover, e.g., a CHO, the CHO to be performed to another IAB node, the network node may be adapted to prioritize an access node which is connected to a same CU such that the CHO is performed intra-CU. However, also an inter-CHO may be performed, that is CHO to an access node connected to a different CU. In both cases, a path from the new, selected access node to the respective CU may use a path that excludes a path that goes over a failed link. When referring again, for example, to FIG. 4 and assuming that the backhaul link 114₅ or the backhaul link 114₄ suffers from RLF, UE₄ and/or UE₅ could connect to DU 318₃ or one of DUs 318₁ or 318₂.
In case the action comprises a CHO, the network node may choose an access node which does not belong to an IAB network, i.e., a network having a different structure; and/or
the network node may connect to a UE or a group lead UE (GL-UE) via a sidelink communication or via a relay node or via a relay UE.

For example, the wireless communication network may provide for a set of at least one proposed access node in terms of an ordered list of access nodes. For example, the ordering may indicate a preference or priority such that an indication is contained in which order the network node is requested to select the access nodes. For example, if an access node with a higher priority is unavailable or unselected by the network node due to side-information, the network node may examine if the next lower priority is suitable. For example, the network node may receive such an ordered list, e.g., a neighbourhood list containing a plurality of designated access nodes of the wireless communication network to which the network node is requested to connect, the plurality being ordered in an ordered list. The network node may select a new access node from the ordered list based on side information. For example, from a UE/network node perspective, the UE can make a decision based on the information provided by the network (for example, select from a list of nodes). The backhaul network may be transparent to the UE.

According to an embodiment, the configuration instructions 376 may indicate a request to disconnect from at least one access node to which the network node is connected when performing the action. According to an embodiment, additional steps may be performed such as a re-connection to the same or a different wireless communication network.

For example, the configuration instructions may indicate a request to disconnect from at least one access node to which the network node is connected when performing the action and to reconnect to the same or another specified node within the configuration after a configured time period or at a given point or event. For example, the access node may be instructed or allowed to try to connect again to this or another cell or access node within a given time period. For example, after this time period, it may be requested if the failure is fixed. The reconnection may, thus, be part of the same action and may be triggered with the same trigger signal but may also be triggered with a separate, additional trigger signal.

According to an embodiment, the network node is configured for performing the action exclusively responsive to the trigger signal, i.e., without own measurements. According to an embodiment, an action may be executed responsive to the trigger signal and responsive to own measurements. For example, some actions such as a simple disconnect or a reconnection may be performed without own measurements. Other actions such as a conditional handover to a suitable access node may include own measurements. That is, the network node may be configured for performing the action based on the trigger signal and based on at least one additional event. The network node may be configured for performing the action based on having determined that the at least one event has occurred, e.g., using own measurements or by receiving the information. The combination of using own measurements and not using own measurements may be separated between different actions to be performed and/or between different operating modes of the network node such that in a first operating mode the network node does not use own measurements and operates exclusively response to the trigger signal and such that in a second operating mode, own measurements are used. This distinguishing between operating modes may be combined with the consideration of different actions.

The at least one event to be determined may relate to one or more of:
event A1, when serving AN signal at the network node (RSRP, RSRQ, SINR etc.) becomes better than a threshold,
event A2, when serving AN at the network node (RSRP, RSRQ, SINR etc.) becomes worse than a threshold
event A3, where neighbour AN signal at the network node (RSRP, RSRQ, SINR etc.) becomes offset better than the serving AN signal at the network node (RSRP, RSRQ, SINR etc.)
event A4, where neighbour AN signal at the network node (RSRP, RSRQ, SINR etc) becomes better than threshold
event A5, where the serving AN signal at the network node (RSRP, RSRQ, SINR etc.) becomes worse than threshold1 and neighbour AN signal at the network node (RSRP, RSRQ, SINR etc.) becomes better than threshold2
event B1, where Inter-RAT neighbour AN signal at the network node (RSRP, RSRQ, SINR etc.) becomes better than thresholdevent B2, the serving AN signal at the network node (RSRP, RSRQ, SINR etc.) becomes worse than threshold1 and inter RAT neighbour AN signal at the network node (RSRP, RSRQ, SINR etc.) becomes better than threshold2an extended number of retransmissions that occur;
an extended number of retransmission covering a time window or period;
a timeout when sending a buffer status report;
a timeout when trying to re-attached to the same cell;
a preconfigured key performance indicator, KPI, e.g., a packet delay, a jitter, an average throughput or the like which is not met anymore over a configured window of time; and/or a preconfigured KPI is not met for a predefined number of times within a given time window.

The time window or period may be based on one or more of:
a hybrid automated repeat request (HARQ) configuration, e.g., a number of HARQ processors, a number of retransmission pair HARQ processors or the like;
a number of radio link control, RLC, retransmissions;
a number of lost packet data convergence protocol, PDCP, packets that a DU memorizes using the existing mechanisms such as downlink data delivery status (DDDS);
a protocol layer, e.g., a jitter of a transmission control protocol, TCP, CO-start window or other connection-oriented protocols; and/or
an application layer, e.g., a hypertext transfer protocol, HTTP, timeout at the network node, e.g., RFC status codes like 404—“page not found” as specified in RFC 2616.

According to an embodiment, the at least one event may comprise at least two events happening on the same and/or on different layers, e.g., cross-layer events, and/or as a sequence of layers. A layer may relate to the ISO-OSI layer model but may also refer to different models. For example, the at least one event may be related to statistics based on a number of events happening on any layer, e.g., physical layer PHY, a stack or application layer, e.g., a higher percentage of retransmission requests on the PHY or on any legs/paths/connections between IAB nodes in case of a multi-hop IAB infrastructure, combined with a large feedback delay on the protocol stack.

According to an embodiment, the network node is configured for performing the action based on at least one event and in absence of the trigger signal when a direct signaling of the network node from the wireless communication network is not possible or not preferred. For example, a respective link 306 in wireless communication network 400 may be unavailable, broken or subject to a different kind of failure. When compared to such impossible communication, a communication that is not preferred may be understood as some way of additional parameters or information to be considered. For example, a network node may have a cheap contract, which is not preferred to access a NR Release 16 gNB, and thus has to reconnect to a different access node. The preference can depend on UE capabilities, UE battery lifetime, UE battery usage in the past, battery health status or the like. That is, the network node may be configured for performing the action based on the at least one event and in absence of the trigger signal when a direct signaling to the network node from the wireless communication network is not preferred based on a capability of the network node and/or based on license agreements associated with the network node. Such license agreements may be stored in a memory of the network node and/or in a database accessible to the wireless communication network.

Indicating an access node to which the network node is requested to reconnect when performing the action may allow to indicate an access node as designated access node in the configuration instructions 376 which might possibly be unselected when the network node would autonomously select an access node. Considering the example in which backhaul link 114₄ or 114₅ of wireless communication network 400 is broken and considering a case in which the UE₄ is requested to simply re-connect to the wireless communication network 400, it might select DU 318₅, IAB node 322₅ respectively for re-connecting, an action which might not help at all as the respective MT of IAB node 322₅ faces an RLF towards DU 318₄ and is therefore disconnected from the donor base station and its CU 312.

The configuration instructions 376 may indicate a set of access nodes for the action. Alternatively or in addition, the network node may receive information indicating neighboring access nodes as the set of access nodes. The network node may be configured to select a selected access node from the set of access nodes. For example, it might be more helpful to connect to DU 318₂ if it is within the range. However, based on a channel condition, e.g., an increased distance, obstacles in the LOS path or the like, this DU may be associated with a lower channel quality such that a metric relating to the channel quality or link quality and/or link capability such as throughput may be lower when compared to a different access node, IAB node 322₅, being reachable for the network node. The link may relate to a higher layer link, above PHY, e.g., this may be on the MAC layer or on the application layer.

Alternatively or in addition, the new node may be a node with a higher backhaul capacity which results in a lower delay to the core network, CN. The network node could therefore select the gNB/network with the lowest delay or jitter, even if the configuration instructions 376 indicate a different node.

The channel quality, the link quality or the link capability metric may comprise one or more of a reference signal received power, RSRP;
a reference signal receive power, RSRQ;
a signal to noise ratio, SNR, of the adopted reference or any other suitable signal;
a signal to interference plus noise ratio, SINR, of the adopted reference or any other suitable signal;
a received signal strength indicator, RSSI, of the adopted reference or any other suitable signal;
a bit error rate, BER;
a block error rate, BLER;
a modulation coding scheme, MCS, levels of cells derived from measurements;
a multiple input multiple output, MIMO, related channel quality information, e.g., precoding matrix indicators, PMI, and/or rank indicators, RI, or the like; and/or
a delay or backhaul capacity.

The configuration instructions may comprise a plurality of actions. Alternatively or in addition, a plurality of configuration instructions may relate to a plurality of actions. Responsive to the trigger signal, the network node may be adapted to select and perform one of the plurality of actions, e.g., based on own measurements and/or decisions. Alternatively or in addition, the instructions may indicate a certain space of decision within which the network node is requested or allowed to perform own decisions.

According to an embodiment, the configuration instructions indicate a plurality of access nodes, e.g., as a plurality of configurations or pre-configurations for a conditional handover, to which the network node may connect. Responsive to the trigger signal 384, the network node 80 may be configured to select at least one of the plurality of access nodes as selected access node and may connect to the selected access node or a plurality of selected access nodes, e.g., by performing at least dual connectivity. The network node may receive, e.g., with the trigger signal 384 or by a separate signal, an indication which access node to select. Alternatively or in addition, the network node may select the access node autonomously, e.g., by sorting the plurality of access nodes according to a criterion and for selecting the access node according to an obtained ranked list. The criterion may comprise, for example, a channel quality, a link quality and/or a link capability metric. Alternatively or in addition, other parameters such as costs, power requirements or interference levels may be considered.

Triggering a network node to perform an action in accordance with configuration instructions may be performed, for example, by transmitting a dedicated signal to the network node. However, embodiments are not limited to such procedures. Instead of triggering a single network node, a plurality of network nodes may be triggered. According to an embodiment, the network node is configured for receiving at least one of a configuration signal comprising the configuration instructions 376 and the trigger signal 384 as a unicast message and/or as a message intended or directed to the network node, e.g., a paging message, and/or as a signal being directed to at least a group of network nodes.

Although embodiments described herein are described so as to overcome the issue related with a backhaul link RLF, instructing the network node to perform the action may also be implemented based on a different criterion, e.g., a network load, delay requirements of data traffic, expected future events within the network or the like. In view of this, it is an advantage to instruct one or more network nodes to perform specific actions. By triggering a group of network nodes, such a reconfiguration may be implemented with a high efficiency. That is, the network node 80 may be configured for receiving at least one of a configuration signal 382 and the trigger signal 384 as a unicast message or as a signal being directed to at least a group of network nodes, e.g., a group cast message or a broadcast message. An example for a unicast message is a message being transmitted during an RRC_CONNECTED mode of the network node may be a message transmitted via the wireless communication network but may also relate to a sidelink communication.

The configuration instructions 376 may indicate a set of access nodes for the action. Alternatively or in addition, the network node may have information indicating neighboring access nodes as the set of access nodes. The network node may be configured to select a selected access node from the set of access nodes.

The network node may be configured to receive the trigger signal 384 as a non-access stratum (NAS) signal. The trigger signal may originate from an entity in the core network such as an access and mobility function (AMF) in 5G core network (5GC), a session management function (SMF) in 5GC, a policy control entity, e.g., residing within the core network or 5GC, an admission control entity, e.g., residing within the core network or 5GC, a network management entity, e.g., residing with the core network or 5GC, and/or a load balancing entity, e.g., residing within the access network, e.g., on a RAN-level, a gNB or a set of gNBs, such as an entity managing this on RAN-level for a set of gNBs and/or residing in the core network or 5GC.

When referring again to FIG. 7, the network node 80 is not limited to receive the trigger signal and/or the optional configuration signal 382 whilst being in RRC_CONNECTED. The network node 80 may receive the trigger signal and/or the configuration signal 382 if used, while being in an RRC_IDLE state 362₂, in the RRC_CONNECTED state 362₃ and/or in the RRC_INACTIVE state 362₄. Embodiments allow to implement different mechanisms to provide the network node with information regardless in which powered state it is.

For example, the network node 80 may receive the trigger signal while being in an RRC_IDLE state 362₂ being associated with a first access node and for changing the association to a second access node in accordance with the configuration instructions 376 responsive to the trigger signal. For example, a request to establish an RRC connection may be transmitted to a different access node after having received the trigger signal.

The network node may receive the trigger signal while being in an RRC_INACTIVE state with suspended connection to a first access node for connecting to a second access node in accordance with the configuration instructions, e.g., when changing to the RRC_CONNECTED state 362₃. For example, it remains inactive until switching to RRC_CONNECTED 362₃ and may then change the access node. Alternatively, the trigger signal may also provoke a kind of wakeup for the network node such that the network node associates with the second, different access node and then returns to the RRC_INACTIVE state 362₄. Whilst changing the access node when changing to an RRC_CONNECTED state having, for example, a need to transmit data, may allow to keep a network load low as, for example, another, more actual configuration may be transmitted meanwhile before the need to transmit data arises. However, when first changing the access node and then return to the idle mode even if there is no data to be sent, may allow for a faster data transmission in case the need arises. Embodiments relate to different kinds of sequences of steps. For example, the network node may first connect to a first access node and then perform the handover to move connection related information to the next, second access node. Alternatively, also different mechanisms are supported in which the network node moves to the second access node without first connecting to the first access node. That is, in the RRC_INACTIVE state, the network node may be connected to a first access node and/or may connect to a second access node when changing to the RRC_CONNECTED state; or may be unassociated to an access node.

The network node 80 may receive the trigger signal 384 and/or the configuration signal 382 as a RAN paging message. The network node may respond to such a paging request by starting an initial access procedure or a physical random access channel, PRACH, wherein the network node may receive instructions related to the action within a related random access response, e.g., in an RRC_CONNECTED state 362₃ or as a reduced instruction set, e.g., pointing towards a new target gNB or representing a new CHO configuration with target gNBs.

In other words, a procedure using short messages via DCI (with or without associated paging message) may implement a kind of trigger signal for idle UEs to inform them of the system information. The receiving UEs may read the updated system information at a next specific radio frame, which tells then they should connect to a new access node. A UE in RRC_INACTIVE state 362₄ may behave as described in connection with the RAN paging message. The network can also send an RRC Release message, sending the inactive UE to an idle mode 362₂, e.g., if it attempts to connect to the first cell. The network can redirect the UE to reselect a different access node, e.g., using the RRC release message. The instructions may also be provided before the UE is going into the idle/sleep mode and does not require a response during the random access procedure to the old node. Embodiments also relate to configuring a target node for the handover.

For example, the network node may receive the trigger signal and/or a configuration signal containing instructions related to the action as a paging message such as a RAN paging message or a short message via DCI or MAC CE. The network node may, for example, respond to a paging request associated with the paging message by starting an initial access procedure or physical random access channel, PRACH. The network node may receive instructions related to the action before going into an idle mode, an inactive mode or a sleep mode and may receive a further condition such as a related initial access response indicating access barring, a related initial access response indicating activation of preloaded configuration and/or a specific identifier/pointer/trigger received together with the first trigger, e.g., the paging signal.

The network node 18 may receive the trigger signal and/or a configuration signal containing instructions related to the action as a release message such as an RRC release message. The network node may change from an inactive mode to an idle mode responsive to the release message and may connect to a different access node responsive to the release message.

The trigger signal 384 may relate to one or more of:
a control signal and/or a flag providing some notification such as quality of service, QoS; and/or comprising
a configuration command such as
   a control or notification signal such as a signal to disconnect, e.g., sent on radio resource control, RRC, or medium access control, MAC, layer; and/or a signal indicating a specific backhaul beam failure or just general backhaul failure;
a flag providing QoS-related notification, e.g.,
   effected service direction (e.g., towards network or from network);
   more specific QoS related degradations such as
      a delay due to congestion, buffering, prioritization or other traffic;
      a delay jitter;
      bandwidth fluctuations;
   a packet error rate, PER, or packet loss;
      an expected time until recovery of service, e.g., in case a UE has little need for immediate data traffic in near future due to buffer capability on service level.

Network node 80 may comprise one or more of a UE, a group lead UE, a relay node and a roadside unit, RSU.

When referring again to an embodiment according to which the network node may have stored a plurality of actions to be triggered, the network node may store at least a first action associated with a first trigger signal and a second action associated with a second trigger signal. The network node may perform the first action responsive to receiving the first trigger signal whilst not performing the second action in this case. Alternatively or in addition, the network node may perform the second action responsive to receiving the second trigger signal whilst not performing the first action in this case.

The network node may be a member of a first group having at least one network node, the first group being associated with the first action. Further, the network node may also be a member of a second group having at least one network node, the second group being associated with the second action. That is, the group-wise reconfiguration of network nodes may also incorporate a UE to be part of two or even more groups. To each group one or more actions may be associated, i.e., respective instructions may be available at the network nodes. The actions may be triggered individually and independently from a respective other group. This is of particular advantage when at least one of both groups to which a network node belongs comprises a plurality of network nodes. The first trigger signal and/or the second trigger signal may be received as a paging message being directed to a group of network devices.

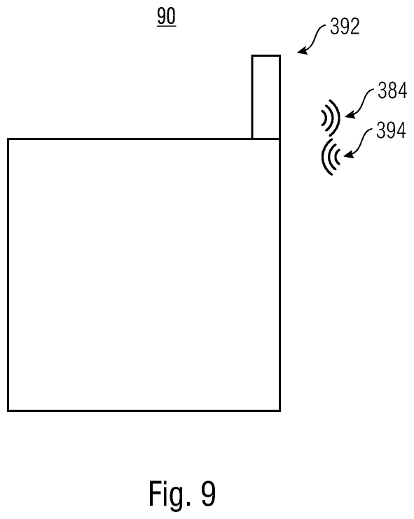

FIG. 9 shows a schematic block diagram of an access node 90 according to an embodiment. The access node 90 may be, for example, an UAV node 322. The UAV node may comprise a wireless interface 392 and may be configured for providing a connection or proxy-access for a network node such as network node 80 or other types of network nodes of a wireless communication network, e.g., the wireless communication network 800. The access node 90 may be configured for transmitting the trigger signal 384, e.g., to a network node such as network node 80. The trigger signal 384 comprises information indicating that the network node is requested to perform an action that causes the network node to disconnect from the wireless communication network and for which the network node is configured or pre-configured. The action relates to a reconnection action to reconnect the wireless communication network, a deregister action, e.g., an access barring, an initiation of a cell-search, a normal handover and/or a conditional handover.

In a scenario in which the access node 90 provides the proxy-access for a network node, the access node may operate by use of a first identifier associated with the access node. The access node may receive a signal containing information to request the access node to operate by use of a second identifier associated with a different access node so as to operate as a proxy for connections of the different access node. For example, the access node may operate by use of two identifiers, one associated with itself and one associated with the different access node. For example, the network may detect loss of backhaul from one or multiple access nodes and may initiate a procedure in which alternative nodes which are still connected to the CU and in proximity close enough to the “disconnected” access node and which are reconfigured such that they transmit signals such as, broadcast signals, etc., mimicking the lost gNBs. Since RRC is terminated in the CU, existing RRC connections can be continued/restored using the newly configured gNBs as proxy gNB. Such proxy gNBs may serve under their original identity and their proxy identity at the same time or in sequence.

That is, the access node 90 may maintain first connections associated with the first identifier and second connections associated with the second identifier in parallel, e.g., simultaneously, or maintain the second connections instead of the first connections, at least for a specific time interval.

The access node 90 may determine and/or be reported to an occurrence of a backhaul radio link failure, RLF, on a path to a CU of the wireless communication network and may determine that the condition of the action is met based on the RLF. Alternatively or in addition, the access node 90 may determine an overload scenario at an access node, a distributed unit, DU, or a CU, and may determine that the condition is met based on the overload scenario. Alternatively or in addition, the access node 90 may determine that at least one network node is to be served by a different access node so as to determine that the condition is met. Alternatively or in addition, the access node 90 may receive information from a higher listed node, e.g., a parent node or a grandparent node, that the condition is met. For example, for access node 322₅, the node 322₄ may be a parent node whilst the node 322₃ may be a grandparent node. For example, the parent node 322₄ may inform the access node 322₅ that it has experienced an RLF and that it is trying to recover (Type 2 failure notification, as described earlier) or that it has failed in the RLF recovery (Type 4 failure notification). That is, the access node may receive information that a node upstream has experienced a radio link failure and tries to recover; and/or information that a node upstream has experienced a radio link failure and failed to recover; and to determine that the condition is met based thereon.

The access node 90 may transmit the trigger signal based on the met condition. That is, the access node 90 may have knowledge about the configuration instructions and/or about the condition to be met to cause the action. If the condition is met, the access node may trigger the network node so as to perform the conditional action. Such information may be derived from own measurements, e.g., when a node determines by itself, possibly direct link to be subject to an RLF (e.g. by the MT on the IAB node), but may also be based on measurements of other nodes that report to downlink nodes an upstream failure. Alternatively, or in addition, the access node 90 may buffer a complete handover (or any other reconfiguration command) and send it when the condition is met. Alternatively or in addition, a CU or a DU may determine a load scenario. For example, a CU may determine an overload based on an indication from a DU that is experiencing congestion on one end of the link. The DU can use the existing interface between the CU and DU to indicate the overload situation. The CU can determine an overload situation at any location within the network, e.g., within its own cell, by means of such a congestion indication provided by a DU and/or another cell being monitored by another CU or other entity. The congestion indication may include additional information, such as whether the congestion has occurred UL or DL, IDs of paths that use the congested link, the node on the other end of the link etc. That is, the access node may preconfigure the handover handover at any time but may also wait for the condition, e.g., the congestion, to be met to transmit the configuration command and/or configuration information to the device to perform the handover. The triggering condition may be related to a congestion scenario in at least one link upstream from the access node.

According to an example, the wireless communication network is to receive a congestion information indicating that a node directly or indirectly serving the access node suffers from congestion; wherein the wireless communication network is to transmit the trigger signal responsive to the congestion information.

The access node 90 may transmit a configuration signal such as the configuration signal 382 to the network node. The configuration signal 382 may comprise configuration instructions related to the action to be performed by the network node, e.g., the configuration instructions 376.

The access node may transmit the configuration signal 382 so as to indicate a single access node for the action, e.g., an access node to be used for a handover operation, or a set of access nodes for the action, e.g., a set from which the network node may determine a selected access node.

The access node 90 may receive the instructions related to the action that are to be incorporated into the instruction signal partly or completely from a network controller, e.g., CN 308 and/or CU 312 of the wireless communication network.

The access node may transmit the configuration signal and the trigger signal together as an execution signal, e.g., execution signal 388, which may incorporate to use a single message and/or separate messages as described in connection with network node 80.

The access node may transmit the trigger signal 384 and/or the configuration signal 382 as one of a unicast message, a groupcast message and a broadcast message. For example, the access node may transmit the trigger signal 384 and/or the configuration signal 382 as a paging message. For example, the transmitted paging signal may be transmitted from the base station/access node to wake up several UEs belonging to a selected group. By defining several paging signals for the same group or parts of the group it is possible to send the virtual trigger and the associated configuration, e.g., sorted beforehand, to be activated.

Embodiments relate to a paging method in which a UE is identifiable by an ID describing/identifying this UE. Furthermore, the same UE is identifiable as a member of a first group by a first group ID describing/identifying the first group, wherein the UE is a member of the first group. Furthermore, the same UE is identifiable as a member of a second group by a second group ID describing/identifying the second group, wherein the UE is a member of the second group. For each of the groups there may be a specific configuration instruction, e.g., CHO configuration, which may be configured, preconfigured or instructed. Specific instructions may relate to UE specific or group specific, meaning the same CHO/action is instructed for all members of the group. If the configuration is UE specific and the UE belongs to multiple groups and the UE specific configurations for the groups are different, then a group paging/triggering may effectively trigger a specific configuration of the UE, where the configuration was preloaded to the UE and activated/triggered by paging the associated group.

According to an embodiment, the access node 90 may transmit the trigger signal and/or a configuration signal related to the action as a paging message. The access node may initiate paging to instruct the particular network nodes to start an initial access procedure, e.g., using a physical random access channel, PRACH, of the wireless communication network. The access node 90 may configure the action at the particular network nodes within a related random access response.

The access node may itself be preconfigured. For example, the access node may obtain a pre-configuration for transmitting the trigger signal 384 and/or the configuration signal 382 indicating that the condition is met, for receiving information indicating that the condition is met, e.g., from a higher listed node. For example, the access node 90 may receive an indicator signal 394 with a wired or wireless interface, the indicator signal 394 indicting that the condition is met. The condition may, for example, refer to a RLF recovery failure by a parent or a higher-listed node, or that a parent or a higher-listed node is trying to recover or the like. The parent or the higher listed node can themselves be preconfigured to e.g. buffer the configuration instructions until an event, such as RLF, is detected. The access node 90 may instruct the at least one network node with the trigger signal 384 and/or the configuration signal 382 in a case the condition is met. That is, the access node may determine that the condition is met based on own measurements or based on a respective indicator signal 394.

The access node 90 may implement the pre-configuration based on applying one or more already stored commands e.g., RRC configuration commands, which include information and/or instructions for itself such as:
Conditional Handover (CHO) configuration,
configuration for handover and/or migration to a different upstream node(s), containing list of possible alternative cells that use different parts of backhaul/IAB network and list of black-listed cells or cell-IDs (e.g. serving cell and other cells effected from the issue in the e2e link),
explicit indication if the handover/migration or CHO configuration refers to intra- or inter-CU handover/migration
re-routing to another AN of the same or different CU of all or a part of the user-plane and/or control-plane traffic
reduction or deactivation of scheduling requests
deactivation of a broadcast indicator that indicates support for other access nodes, such as IAB-nodes, to connect to the AN

Alternatively, or in addition, the access node 90 can send configuration commands such as the above to another access node before it applies its own already stored commands.

The access node 90 may implement the pre-configuration based on applying one or more already stored commands and send to the network node, e.g., RRC configuration commands, which include information and/or instructions such as:
list of black-listed cells or cell-IDs (e.g. serving cell and other cells effected from the issue in the e2e link),
no reconnection to the current serving cell
list of possible alternative cells that use a different backhaul/IAB network
push command to the network node to perform a handover, HO/conditional handover, CHO
Target cells for HO/CHO for individual UEs, group of network nodes or all network nodes,
Conditional Handover (CHO) configuration,
access barring, e.g., for network nodes in IDLE MODE, e.g. gNB signals UE that it is not allowed to connect for a certain time or indefinitely
deregistration of network nodes (for UEs in CONNECTED or INACTIVE modes).
initiating a paging after a particular time or after reconnection to the network to all its former members (UEs)
sending network nodes into a sleep-like mode with a given time window, wherein the UE is requested to do a primary action specified after the given time window has lapsed or another condition is met; or wherein the network nodes are requested to perform a secondary action if the time window has lapsed and the primary action cannot be successfully executed, e.g. reconnect after 5 minutes as primary action, if not possible access network via, e.g. BS538, as secondary action.

The access node 90 can send the configuration commands without performing any further action on its side.

Alternatively, the access node 90 can send the configuration commands before it applies its own already stored commands.

Alternatively, the access node 90 itself can first perform a migration/handover or apply its own reconfiguration instructions before sending to the network node the above instructions. For example, the access node 90 may handover/migrate to a different parent after applying its own configuration instructions. The access node 90 can then send the stored configuration commands to the network node or another access node after it has successfully connected/performed random access to another parent.

The access node 90 may determine and/or be reported to an occurrence of a backhaul radio link failure, RLF, on a path to a CU of the wireless communication network and may determine that the condition of the action is met based on the RLF. The reported indication may refer to RLF recovery failure, or that the parent or a higher-listed node is trying to recover or the like. Based on the event, the access node 90 may perform re-routing of all or a part of the user and/or control traffic to another access node within the same or different CU. Such re-routing can be performed autonomously by the access node, based on routing configuration/pre-configuration by the CU. Alternatively or in addition, the access node 90 may determine an overload scenario at an access node, a distributed unit, DU, or a CU, and may determine that the condition is met based on the overload scenario. Alternatively or in addition, the access node 90 may determine that at least one network node is to be served by a different access node so as to determine that the condition is met. Alternatively or in addition, the access node 90 may receive information from a higher listed node, e.g., a parent node or a grandparent node, that the condition is met. For example, for access node 322₅, the node 322₄ may be a parent node whilst the node 322₃ may be a grandparent node. For example, the parent node 322₄ may inform the access node 322₅ that it has experienced an RLF and that it is trying to recover (Type 2 failure notification, as described earlier) or that it has failed in RLF recovery (Type 4 failure notification).

The access node 90 may comprise one or a combination of:
a single or multiple access points that can be, for example, a base station, BS, eNB, gNB, DU, CU, remote radio head, RRH, IAB-node, another UE providing radio access via, e.g., SL, a group leader UE
an access point that the UE is already connected to, e.g., its serving cell,
an access point that the UE is not connected to, e.g., a base station within the cell of a tracking area of the given UE.

According to an embodiment, the access node, e.g., implemented as a CU, is to inform a target access node being a possible or selected target for a handover or a conditional handover as the action.

As described for the network node, the access node may be implemented for at least a dual connectivity.

In other words, embodiments incorporate a set of ideas that are explained again in other words in the following:

AN-triggered gNB Reselection for UEs with CHO configuration/Enhanced Conditional Handover (eCHO)

One proposed solution is based on CHO and envisages a similar configuration procedure of the UE and target BSs. The addition is that this so-called enhanced CHO (eCHO) can also be triggered or enforced by configuration through signaling or by an event, or a combination of both. The eCHO can be realised either as unicast signaling to a specific UE or as broadcast or group-cast signaling for a group of UEs.

The configuration source by signaling can be from the network, e.g. from the source BS or from the currently connected DU in case of a split architecture, e.g. C-RAN or IAB system architecture, in case the UE still has connectivity to the mentioned network entities. Embodiments of this invention introduce a new signaling, in case the link to a CU is broken and the UE has still connectivity to one or more DUs. Other embodiments highlight the case that the UE still has connectivity to a core network (CN) such as a 5GC. This might be the case if there is a nested 5GC setup, such as a campus network, which is described in more detail below.

In other embodiments when a direct signaling to the UE is not possible or not preferred, e.g. the network operator does not want to reveal this type of information, the CHO configuration can be enhanced by triggering on additional events or combination of events. Here, an event can be an extended number of retransmissions covering a time window or period, which is configurable when the upstream or downstream of a Backhaul link could be the unknown cause, combination of events, or events happening on different layers (cross-layer), or sequence of events. Here, the time window/time period may depend on any of the following:
the HARQ configuration, e.g. number of HARQ processes, number of retransmissions per HARQ process etc.,
the number of RLC retransmissions,
the number of lost PDCP packets that DU memorizes using the existing mechanisms such as Downlink Data Delivery Status (DDDS),
Application layer, e.g. HTTP— timeout at the UE, e.g. RFC status codes like 404—“Page not found” as specified in RFC2616.

DDDS is a mechanism which provides downlink data delivery status from the corresponding node to the node hosting PDCP. In split gNB architecture, a DU (the so-called corresponding node) provides the CU (the node hosting the PDCP entity) with a status report on delivered PDCP PDUs to the UE with the objective to control the downlink user data flow for the respective data radio bearer ([13]). This mechanism can also be reused in IAB networks for end-to-end flow control, and to prevent or mitigate the congestion over wireless backhaul links. In case of IAB, the corresponding node refers to the access IAB-node DU functionality serving the UE for the corresponding data radio bearer.

Finally, the events might also cover statistics based on a number of events happening on any layers (PHY, stack, application layer), e.g. a higher percentage of retransmission request on the PHY or on any legs between IAB nodes in case of a multi-hop IAB infrastructure, combined with a large feedback delay on the protocol stack could trigger the UE to perform an eCHO.

Embodiments cover how an eCHO can be executed, which can comprise of any combination of the following:
Immediately with the execution command,
With a predefined (fixed or configurable) delay,
At execution and time preference of the UE, e.g. based on its load condition of the UE, battery power, moving speed, etc.,
With another event/condition to be met and then again immediately or delayed.

The UE could refine its choice of a new AN within its eCHO based on certain side information:
The potential new access node(s) chosen for or by the UE, which could be a part of the latest measurement report.
In case of eCHO to another IAB node or a DU, the priority could be given to intra-CU eCHO. The indication whether this is intra or inter-CU HO is signaled to the UE, as a part of eCHO configuration. Regardless if it is intra- or inter-CHO, the path from a new access node to a CU should not use the paths that go over a failed link.
In case of eCHO, the UE might choose an access node, AN, which does not belong to an IAB network. Although this is typically kept hidden from the UE, the UE might choose to HO to a target BS which has a considerably lower delay or a target BS which is marked in the eCHO configuration as belonging to a non-C-RAN OR NON-IAB network.

The BS could recommend/command the UE to select/perform eCHOto new AN sending the particular AN or a set of ANs, e.g. as a listthat the UE can choose from as described by way of example with the ordered neighbourhood list. This can be an ordered list that the network node may follow, i.e. the network node first selects the first AN from the list. If the network node cannot perform eCHO to the first AN because, e.g. reference signal RSRP/RSRQ/SINR is too low or for any other reason, the network node may proceed with eCHO to the second AN and so on.

Furthermore, in another embodiment, the proposed mechanism depends on the current state of the given UE. If the RRC sublayer connectivity breaks, the UEs cannot be addressed by a given DU or IAB-node. In these cases, the DU or IAB-node have to provide a new type of signaling, in order to inform the UE to perform an eCHO. In case the UE perceives it is still in an RRC_CONNECTED state, certain PHY messages and/or MAC CE elements could still be received by the given UE, although the backhaul network has experienced a backhaul RLF. In this case, a short signaling from the DU or IAB node could trigger a particular HO to a target cell which still has the required backhaul capacity.

The following section will describe some possible scenarios where signaling and/or event-based triggering of eCHO in more detail.

One possibility for triggering eCHO is non-access stratum (NAS) signaling. In case of NAS signaling, the trigger for an eCHO originates from an entity in the core network. Examples of such an entity are:
access and mobility function (AMF) in 5G core network (5GC), or
session management function (SMF) in 5GC, or
a load balancing entity residing within the core network.

The network entity may trigger the handover for one or more UEs, considering one or more of the followings (the list is not exhaustive):
network's policies,
restrictions, e.g. access restrictions, mobility restrictions, user subscriptions,
mobility patterns of the UE, and/or other UEs,
load balancing, or the load in fronthaul or backhaul network.

Scheme 1: direct NAS signaling to the UE: As an example, AMF in 5GC has an N1 interface to the UE. Consider a UE that is already configured for a conditional handover to at least one particular target BSs. In this scenario, the AMF can signal the UE over N1 to trigger the handover to the preconfigured target BS. In that case, the UE will perform the handover regardless of detecting/not detecting CHO events.

Scheme 2: HO decision is made in core network, but the trigger is signaled from RAN: In another example, AMF in 5GC decides to trigger the CHO (similar to scheme 1 above). AMF signals the RAN or the serving BS (over N2 interface) about this decision. The serving BS signals the UE (e.g. through RRC signaling) to perform the conditional HO to the preconfigured target BS.

In another scenario, the NAS of a nested CN could trigger the eCHO. A Nested CN could be within a configuration of a campus network. Here, the campus network is like a private Intranet, implementing its own 5GC with a reduced functionality required to cover a certain area, e.g. a manufacturing site of a company. In this example, some of the services can be treated as internal services, e.g. Intranet, which can be supported if a UE is RRC_CONNECTED to that given network. In case the connection through the campus network breaks, the BS within the campus network could trigger a UE to perform an eCHO, e.g. in case the given UE does not require internal services but request services from the external network, e.g. Internet. In this embodiment, it can be avoided that UEs flood the network (Intranet) with service flows which cannot be supported anyways, since the connection to the outside network is broken. In another embodiment, the particular UEs could be pushed to use or not use certain services, as well as to use services only over alternative connections/networks.

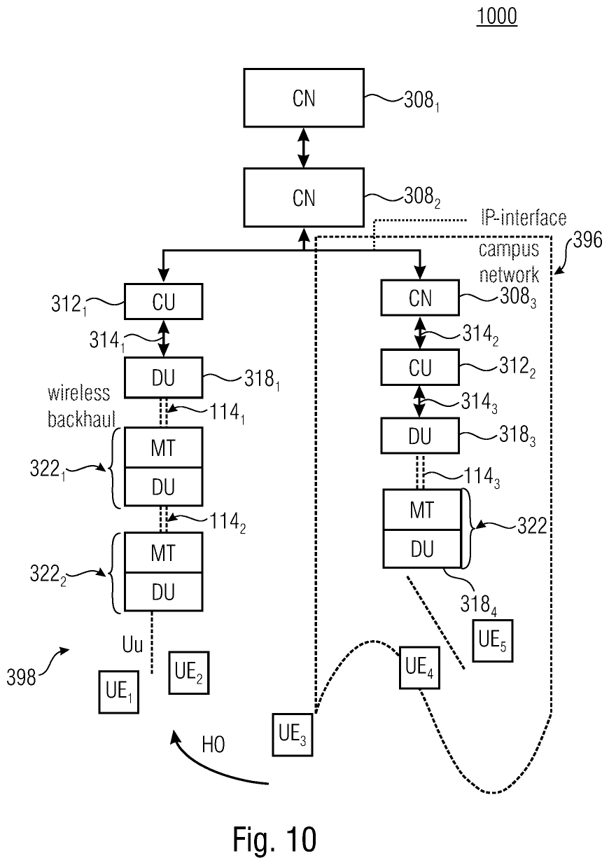

Such a scenario is illustrated, for example, in FIG. 10 showing at least a part of a wireless communication network 1000, comprising a part 396 which may be referred to as a campus network being connected to one or more instances of a core network 308₁ and 308₂ via an IP-interface. The part 396 or campus network 396 may comprise a campus core network 3083 being in communication with a donor base station and its CU 312₂, e.g., by a wired link 314₂ indicated by the solid line. Dashed lines indicate a wireless link. In FIG. 5 an action is illustrated being referred to as a handover, HO, from the campus network 396 to an outside network 398. However, embodiments are not limited hereto but also allow a handover into the campus network 396, e.g., coming from the outside network 398.

FIG. 10 shows a scenario in which the UE is pushed from the campus network 396 to the external network 398, e.g., in case of an RFL or connection failure of the campus network to services outside the campus network.

That is, the indicated target node may be DU 318₂ and the condition to be met is a link failure towards the CN 308₁ or 308₂ via CU 312₂.

In an embodiment, the AN could make use of so-called conditional neighborhood lists.

In wireless communications networks, e.g. 4G/5G networks, the 3GPP specifications define the functionality of Automatic Neighbour Relation (ANR), see[14], which, among others, automates the tasks of optimisation of the neighbourhood list. eNB/gNBs with such functionality can then instruct the UE to perform measurements on neighbour cells according to specific polices and define when UEs are to report them back to the network. Such lists of the neighboring cells can be provided to the UE in order to reduce effort in search, detect and tracking of other cells. These neighborhood list can be configured in size and complexity, e.g. included number of cells/BS, available bands in each RAT. This allows to perform vertical or horizontal HO.

Such neighborhood list can be provided by the MNO or via exploration from observing UEs and reporting to the network. Such features are defined in [15], Minimization of Drive Tests (MDT) and can be triggered and configured by the network.

Such mechanism could be further extended two-fold:
1.) A UE connected to an AN in the exemplary IAB network may be requested to provide information about all other AN around (using means and mechanisms provided by MDT framework) by reporting cells such as Pas and/or CGIDs that it can receive. The UE can also be configured or preconfigured to only report a smaller number of cell identifiers or a top-m set of cell IDs. Such observation may provide insights into:
   a. Alternative branches that are available to the UE in case one of the BH links may be lost or become insufficient with respect to the requested QoS-level.
   b. Critical alternative ANs which may provide continued service if a particular BH goes down,
   c. May provide side information to prepare/provide minimized set of target ANs for eCHO.
2.) With the obtained knowledge, the base station can calculate and provide:
   a. A conditional neighborhood list exemplarily with:
      i. Blacklisted nodes of a certain branch to indicate, that such nodes are to be ignored/not accesses/avoided if serving node loses BH connectivity, e.g. blacklisted nodes can belong to the same backhaul branch suffering from the same connectivity failure.
      ii. Preferred or ranked order of alternative ANs to be approached/used for eCHO in case of a condition is met, including cell ID and/or the information required for random-access procedure, contention-free preferably, as well as beam-specific information.
      iii. Such conditional neighborhood lists could be enriched with UE or UE-group specific inclusions/exclusions of list entries, priorities, ranked orders, service type etc. (in this way the neighborhood list might be larger than the number of base stations an individual UE is observing at a particular location). E.g. UEs operating services with high QoS-needs, are pushed to ANs which can provide the required services.

Furthermore, such conditional neighborhood list can be used to configure explicitly or implicitly the task for neighborhood exploration via MDT, e.g. report only on base stations with a particular order/selection. Such selection/order may come from explicit/implicit knowledge about the backhaul tree behind the IAB network.

A similar reason of signaling can be triggered from the AN, e.g. a BS or the DU directly, in case there is an overload condition at that BS or CU or DU. The reason for this could be that the bandwidth part (BWP) supported by a given DU is limited, and the number of supported UEs of a certain KPI, e.g. URLLC; has been reached. In this case, an eCHO could be triggered by the BS or CU or DU, in order to force the UE to HO to anther BS to free up resources for the other UEs, and in addition, to enforce that the UEs performing the eCHO are served with the QoS they requested

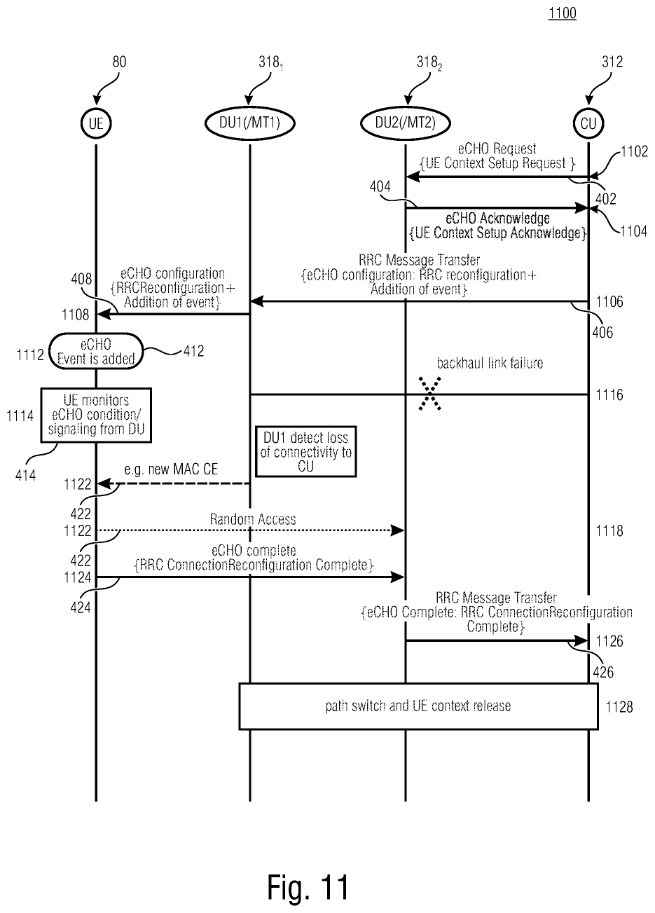

FIG. 11 shows a schematic flow chart of a method 1100 according to an embodiment illustrating the triggered execution of the action by way of a backhaul link failure. For example, a network node 80 operates as a UE, e.g., one of the UEs illustrated in the wireless communication networks described herein. In 110₂ a central network node such as CU 312 prepares for the action to be done, e.g., it may transmit a signal 402 such as an eCHO request containing a UE context setup request. Such a preparation signal 402 may be transmitted, for example, to a DU 318₂ that possibly communicates with a mobile terminal (MT), e.g., forming an IAB node 322. DU 318₂ may be selected by the network so as to form a possible access node for the handover performed by UE 80. In 1104 the requested DU 318₂ may send an acknowledge 404, e.g., an eCHO acknowledge containing a UE context setup acknowledge. At 1106 a signal 406 is transmitted from CU 312 to DU 318₁ serving UE 80. Signal 406 may indicate an RRC message transfer and may contain an eCHO configuration, e.g., an RRC reconfiguration and, additionally, information indicating an event. At 1108 of method 1100 a signal 408 is transmitted from DU 318₁ to UE 80 to configure UE 80. For example, signal 408 may at least partially comprise information of the configuration signal 382, i.e., the configuration instructions 376. Signal 408 may, thus, be an eCHO configuration having the RRC reconfiguration and has the addition of an event. By processing signal 408, UE 80 may add the event indicated in signal 408 to an enhanced conditional handover and may arrive at a state 412 in which an eCHO event is added. At 1114 the UE may optionally monitor the eCHO condition and may receive a signaling from DU 318₁ indicating that an action needs to be performed, based on the event that has occurred in 1116.

In 1118 DU 318₁ may detect the loss of connectivity to CU 312. Based thereon, it may transmit a signal 422 in 112₂ of method 1100, i.e., along the other direction when compared to the direction along which the link fails. When informing UE 80 downlink, e.g., with a new medium access control, MAC, control element, CE, 422, UE 80 may transmit one or more signals 422 relating to a synchronization and random access procedure forming part 112₂ of method 1100. A signal 424 may be transmitted when the handover, the eCHO is complete. Signal 424 may contain an RRC ConnectionReconfiguration Complete information. Thereby, UE 80 may associate with DU 318₂, i.e., performing the handover. DU 318₂ may inform CU 312 about the handover in 1126, e.g., using a signal 426 indicating an RRC message transfer, e.g., containing an eCHO complete: RRC ConnectionReconfiguration Complete information. In 1128 the path may have switched and UE context may be released (e.g. when the backhaul becomes available again).

In other words, FIG. 11 shows the case where the procedure is triggered by a signal (a new MAC Control Element) by the DU, but could also be done using, e.g. DCI. In this example, the links between DU1 and CU and between DU2 and CU, respectively, represent logical links, with intermediate IAB nodes connecting DUs with the CU. The RRC messages to the UE are sent via DU1 and subsequently via DU2. For transport of RRC messages between CU and DUs, the existing RRC message transfer may be used.

In addition to eCHO initiated via dedicated signalling, eCHO can be instigated by using broadcast signalling to all UEs in connected mode. In that case, a new SIB could contain all the required parameters for this cell-wide eCHO—the presence of which could be indicated in the main SIB, i.e. SIB1. The DU, again, could be preconfigured with a specification of an event, such as loss of connectivity to the CU. Upon a detection of such an event, the access DU would signal system information change via e.g. DCI for all UEs in the cell (idle/inactive and connected) to read the new system information The UEs in connected mode would apply configuration from the new SIB and perform eCHO.

Some scenarios may relate to a UE being in a connected state, e.g., a registered or connected state such as states 362₃. However, embodiments are not limited hereto but also provide solutions for a state in which the UE is in an idle mode such as state 362₂ and/or an inactive state such as 362₄.

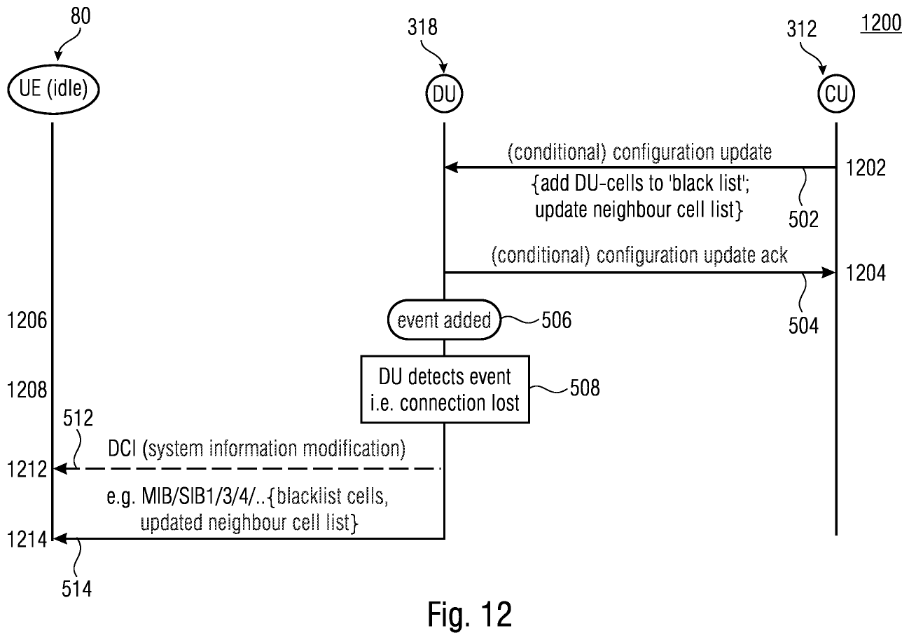

FIG. 12 shows a schematic flow chart of a method 1200 for informing idle UEs such as UE 80 about the action to be performed. In 1202 of method 1200 CU 312 may inform DU 318 by use of signaling 502 about a configuration update or conditional configuration update. For example, this may include to add one or more DU-cells to a so-called blacklist. Alternatively or in addition, a neighbor cell list may be updated. In 1204 of method 1200 DU 318 may acknowledge this information by sending a signal 504 to CU 312, e.g., a configuration update acknowledge or a conditional configuration update acknowledge. In 1206 of method 1200 this may result in an added even 506 at DU 318. At 1208 of method 1200 the DU may detect the triggering event, e.g., a lost connection as described for 1116 of method 1100 and 1118 of method 1100. At 1212 a signal 512 may be transmitted to the idle UE, e.g., using a short message via a downlink control information, DCI, to inform it of a system information modification. At 1214 one or more signals 514, e.g., a master information block, MIB, a system information block, SIB such as SIB1, SIB3 or SIB4, including the modified information, e.g. the blacklisted cells and/or the updated neighbor cell list are broadcast and read by the UE.

In other words, an idea of the described embodiments relates to an access node-triggered gNB reselection for UEs in idle/inactive mode. While the problem of stationary, idle UEs is not as critical as in the case of UEs in connected mode (RRC_CONNECTED), the issue is still present as the UE will perform random access procedure to the AN that provides it with the strongest signal. However, the AN has no connectivity to the CU/core network in the case of an RLF in the backhaul network. Hence, while the random access procedure may be successful, the subsequent RRC Connection request will not reach CU and the UE may go through this procedure again.

Proposed solutions:

Broadcast

In known procedures, for the UEs in idle mode, system information is acquired from broadcast of system information blocks. If there is a requirement for a change in system information, such change occurs only at specific radio frames when UE monitors physical control channels for paging. Firstly, the network notifies the UEs about the system change through specific messages. This can be a paging message that uses the paging channel or the Short Message field in DCI (TS 38.331). In the next modification period, the network transmits and the UE acquires and applies this new system information.

The proposal in this embodiment for stationary UEs and UEs coming into the coverage of the cell that has no connectivity to the CU/core network is to prevent camping on cells of that DU. The appropriate broadcast (system information) blocks can be used for that. Hence, broadcast channel could be altered such that the UEs in IDLE/INACTIVE modes listen and read the markers that indicate “barring” for all UEs who have not been served by this cell. Additionally, the updated system information could include new (updated) neighbourhood list, which could implicitly or explicitly indicate that UE should perform RACH towards the best cell from the new, updated neighbourhood list.

In [8] and [7], broadcast of updated system information is discussed in the context of RRC Connection Reestablishment failure of the IAB nodes, that is their respective MTs.

In the proposed solution here, the DU is preconfigured by means of existing signalling procedures, with a specification of an event, such as RLF of its MT, which causes a. loss of connectivity to the CU. Upon a detection of such an event, the DU first sends the DCI signal to inform UEs of a change in the system information and then broadcasts the updated system information that include, e.g.:
MIB indicating barred cell for UEs coming into the coverage area of the cell
SIBs indicating barred/blacklist cells and updated neighbourhood list for the UEs camping on that cell.

Such a concept is shown in FIG. 12 showing an example of a broadcast solution for an idle UE. Note that the connection between the CU and the DU goes over a wireless backhaul link which is not illustrated in FIG. 12. The solution described relates to the case of a single hop. This solution may also be extended for multiple hops downstream, where all the nodes that have a single connection to the CU and use the part that crosses or incorporates the failed backhaul link, send and updated system information to their UEs.

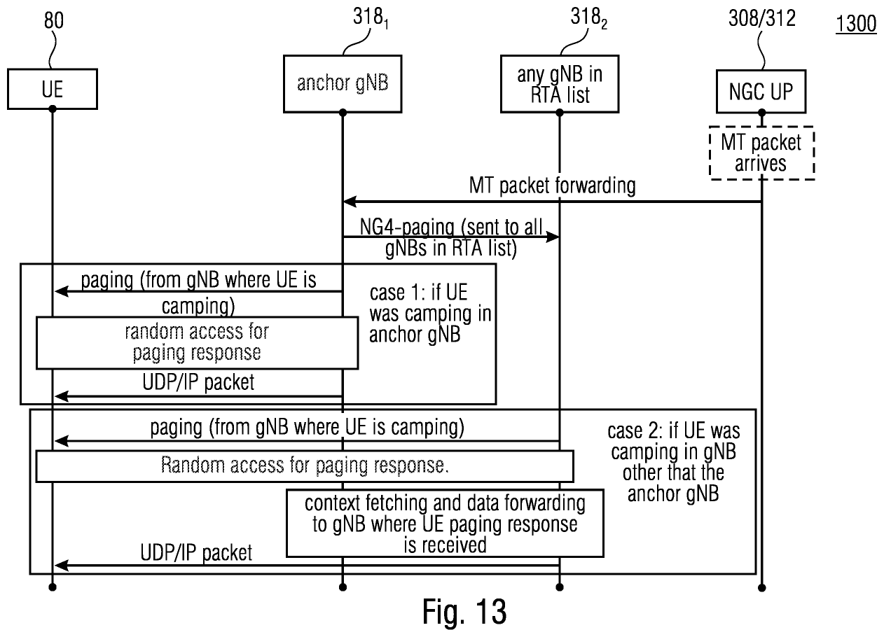

FIG. 13 shows a schematic block diagram of a method 1300 being known for paging.

Paging

In NR, paging originates from AMF (which takes the role of MME in the EPC of LTE networks). For UEs in IDLE mode, paging is CN-initiated/5GC-initiated. On the other hand, for UEs in RRC_INACTIVE state, there is a RAN-initiated paging. For this, a

RAN-based notification area is configured. The gNB knows which RAN notification area the UE is camping on and only sends the paging in that area in order to reduce the radio resources consumed on paging. The typical procedure for RAN-initiated paging is depicted below. In general, this is initiated when the anchor gNB received data from the NGC. In embodiments of this invention, the paging message send from the anchor gNB within the box labelled “Case 1: . . . ” in FIG. 13. shall be sent by the anchor gNB in case its backhaul is broken.

That is, FIG. 13 shows a potential RAN-initiated paging procedure for UEs in RRC_INACTIVE state. Embodiments related to a modified paging message when compared to FIG. 13, the modified paging message informing the UE on barring this cell or barring this cell for a particular time period. In a further embodiment, the gNB shall initiate a paging request to the particular UEs, which would then start an initial access procedure or physical random access procedure, PRACH. Within the PRACH, the gNB may configure the UE within the random access response, e.g., MSG2 or MSG4 or MSGB in case of a two-step RACH that the UE needs to perform an eCHO to another cell. Furthermore, the particular gNB may signal recommendations of candidate cells as described in further embodiments of the present invention relating to eCHO. One or more network nodes, e.g., network nodes in accordance with the description of network node 80 and one or more access nodes such as network nodes 90 may form a wireless communication network in accordance with embodiments. Some possible functionalities have been described in connection with wireless communication networks of the accompanying figures.

Direct Signaling from AN to UE

The following section defines different ways to signal from the network to the UE information on the backhaul status or event, e.g. RLF, such that the UE can perform particular actions to avoid dropping of a service.
1) Network informs the UE through signaling about the issues in the network/backhaul that UE cannot directly see/sense.

The information that is sent to the UE can be a simple control signal or a flag providing some e.g. QoS notification or can be a configuration command. Some examples are listed in the following:
Control or notification signal such as:
   Signal to disconnect, e.g. sent on RRC or MAC layer,
   In addition to what is proposed in [7](indicating backhaul RLF within the system information to bar access for this node and potentially including ancestor nodes), the signal could indicate a specific backhaul beam failure or just a general backhaul failure.
A flag providing QoS-related notification
   Effected service direction (towards network or from network),
   More specific QoS related degradations, e.g.
      Delay due to congestion, buffering, prioritization of other traffic,
      Delay jitter
      Bandwidth fluctuations
   Packet error rate (PER) or packet loss
   Expected time till recovery of service (in case a UE has little need for immediate data traffic in near future due to buffer capability on service level).

In known methods, the radio access network, specifically Service Data Adaptation Protocol (SDAP) sublayer uses mapping rules to associate UL/DL QoS flows (defined in 5G Core network) with data radio bearers. All packets mapped by SDAP to the same DRB have the same packet forwarding treatment. In split architecture, SDAP sublayer is located in the CU. Here, F1 UE context management function between CU and DU is used to manage data radio bearers. For the IAB-based backhaul, the intermediate IAB nodes are configured through F1 (and RRC) procedures to map the UE DRBs to the appropriate backhaul RLC-channels and provide suitable treatment of the UE data radio bearers. In both IAB and non-IAB mode of operation, RAN may not always be able to meet the QoS profiles requested by the core network. To handle this scenario, [16] defines an N2 procedure which allows the RAN to reject the QoS profiles requested by the core network, in case the RAN cannot meet them. This N2 procedure is applicable to both IAB and non-IAB mode of operation.

In this embodiment, a form of QoS notification that originates in the AN is proposed. For example, in the case of backhaul RLF, the access DU can provide the UE with a simple flag (originating, e.g., from MAC layer) that indicates, through cause codes, service degradation, as some of the examples outlined above.

According to an embodiment, a DU (or another node) can be preconfigured that in the case of a loss of connectivity between UE and the CU applies and sends to the UE some already stored (RRC) configuration commands, such as:
List of black-listed cells or cell-IDs (e.g. serving cell and other cells effected from the issue in the e2e link),
No reconnection to the current serving cell
List of possible alternative cells that use a different backhaul/IAB network
Push command to the UE to perform a HO/CHO (similar to eCHO)
   Target cells for HO/CHO for individual UEs, group of UEs or all UEs,
   Conditional Handover (CHO) configuration,
Access barring (for UEs in IDLE MODE), e.g. gNB signals UE that it is not allowed to connect for a certain time or indefinitely
Deregistration of UEs (for UEs in CONNECTED or INACTIVE modes).

The information can be sent to a single UE/or it can target a group of UEs or all UEs using dedicated signaling or multicast/broadcast.
2) The network entity that sends this information to the UE can be one, or any combination of the following:
   Single or multiple access points, that can be: BS, eNB, gNB, DU, RRH, another UE via SL, a group leader UE
   An access point that the UE is already connected to (e.g. its serving cell),
   An access point that the UE is not connect to it (e.g. a BS within the cell of a tracking area of the given UE).
3) Furthermore, on detection of an EVENT the network entity will inform/message the target DU (access point which could/will handle the UE in future) AND/OR source DU (access point which is currently handling the UE in wireless access).
4) Dual connectivity to be used for informing the UE about the issue and further actions.

A wireless communication network in accordance with embodiments may comprise an entity in the core network such as CN 308 which may be one or any combination of:
an AMF in 5GC; an SMF in 5GC;
a policy control entity, e.g., residing within the core network or 5GC; or
an admission control entity, e.g., residing within the core network or 5GC; or
a network management entity, e.g., residing within the core network or 5CG; and/or
a load balancing entity, e.g., residing within the access network, e.g., on a RAN-level, a gNB or set of gNBs, such as an entity managing this on RAN-level for a set of gNBs, and/or residing in the core network or 5GC. Such entities or combinations thereof may provide for the trigger signal.

The wireless communication network may trigger the action for one or more network nodes. This may be implemented by use unicast, group cast and/or broadcast messages. The network may consider one or more of the following:
one or more networks policies;
restrictions, e.g., access restrictions, mobility restrictions and/or user subscriptions;
mobility patterns of one or more UEs and/or other UEs;
load balancing, a load in the fronthaul back work and/or the backhaul network;
deficiencies in the transport network topology connecting the access nodes to the RAN and/or core network;
other parameters.

According to an embodiment, the wireless communication network may determine the action to be performed so as to comprise a handover, e.g., a conditional handover or a regular handover and to instruct a plurality of network nodes as a group of network nodes so as to perform a group handover to a same or to different target access nodes. This may be done, e.g., for considering load balancing. An overload or underload at one or more links may be a trigger to reselect an association of UEs as well as a link failure of a group of UEs being connected through a same backhaul link with the core network. Although it is possible to relocate all the UEs to one single different access node, it may be of advantage to distribute them amongst more than one access node, if possible, so as to avoid overload situations in the backhaul network.

According to an embodiment, the network may instruct at least one network node to observe a neighborhood and to provide a report indicating the observed neighborhood, i.e., the UE neighborhood. The wireless communication network may determine at least one access node for the conditional handover based on the reported neighborhood. That is, the network may have knowledge about the neighborhood of one or more UEs and may decide the action to be performed based on the neighborhood.

According to an embodiment, the wireless communication network may provide the network node with a set of at least one proposed target access nodes. For example, this may include a conditional neighborhood list, which may be in a form of ordered list. The action may include a reconnection, the reconnection may have a target access node having one or more of the following features:
the target access node is not an IAB node or at least part of a different IAB network so as to avoid occurrence of same or related IAB link failures;
the target access node is not on the same path to the core network as the current access node from which the network node disconnects; and/or
the target access node does not share the same backhaul infrastructure as the current access node.

According to an embodiment, the wireless communication network may provide the network node with the set of proposed target access nodes so as to comprise a plurality of access nodes from which the network node may select at least one. Instructions provided by the wireless communication network may relate to a decision space from which the UE may select or an ordered list or a general a preference of the network which may or may not be subject to an overwrite by the UE and/or a concrete instruction with alternatives in case the instruction may not be executed or is preferably not executed based on other parameters.

According to an embodiment, the wireless communication network may request the network node to provide information about other access nodes around, e.g., access nodes it may determine or sense, observe or detect. The determined nodes may be filtered or limited, e.g., so as to report only those access nodes that fulfil a criterion, e.g., a specific throughput, a channel quality, a delay or the like. Thereby, the network node may be requested to report a smaller number of cell identifiers than being observed by the network node. Alternatively or in addition, a top-M set of cell IDs may be reported, e.g., a predefined number of cells that fit the criterion or that best fit the criterion. In other words, access nodes that fulfil the criterion may be reported and/or a limited predefined number may be reported. This may allow to avoid unnecessary reporting of access nodes or cell IDs which are not likely to be considered for future decisions.

According to an embodiment, the wireless communication network may select one or more access nodes for the conditional handover, e.g., based on the reports of the UE and/or based on one or more of:
alternative branches that are available to the UE in case one of the backhaul links may be lost or becomes insufficient with respect to a requested QOS-level or other parameters;
critical alternative access nodes which may provide continued service if a particular backhaul link goes down;
side information provided to the access node to prepare/provide a minimized set of target access nodes for the conditional handover.

According to an embodiment, the wireless communication network may provide, based on the reports, a conditional neighborhood list to the network node, which may be in a form of ordered list. This may allow to provide the network node with a basis for a later decision in view of, for example, a reconnection or handover. According to an embodiment, the conditional neighborhood list may comprise one or more of
blacklisted nodes of a certain branch to indicate that such nodes are to be ignored/not accessed/avoided if the serving node loses backhaul connectivity, e.g., blacklisted nodes can belong to the same backhaul branch suffering from the same connectivity failure which may be, however, unknown to the network node;
preferred or ranked orders of alternative access nodes to be approached/used for a handover being at least a part of the action in case a condition is met, including a cell ID and/or the information required for random-access procedures, preferably contention-free, as well as beam-specific information; and
the conditional neighborhood list so as to be enriched or incorporating inclusions/exclusions of list entries, priorities, ranked orders, service types or the like, the inclusions/exclusions being specific for a network node or a group of network nodes, e.g., UEs operating services with high QoS-needs are pushed to an access node which can provide the required service and/or vice versa.

According to an embodiment, the wireless communication network may provide the conditional neighborhood list to configure the network node explicitly or implicitly for neighborhood exploration via minimization of drive tests, MDT, e.g., report only on base stations with a particular order/selection.

According to an embodiment, the wireless communication network may be implemented such that the configuration of the conditional handover is determined in a core network of the wireless communication network and/or central unit and/or at a distributed unit of the wireless communication network. The trigger signal may be initiated by the core network of the wireless communication network and/or at the same or a different central or distributed unit. Same relates to other types of actions.

According to an embodiment, the wireless communication network may configure at least one network node to be a member of a first group of network nodes and of a second group of network nodes. The wireless communication network may provide the first group of network nodes with a first trigger signal being associated with the first action and for providing the second group of network nodes with a second trigger signal being associated with the second action.

For example, the wireless communication network may be adapted to comprise a plurality of network nodes in the first group and/or in the second group. Alternatively or in addition, at least one group may be formed by a single network node.

According to an embodiment, the wireless communication network may transmit, to the network node, the first trigger signal and/or the second trigger signal as a paving message being directed to a group of network nodes.

In accordance with embodiments, the wireless communication system may include a terrestrial network, or a non-terrestrial network, or networks or segments of networks using as a receiver an airborne vehicle or a space-borne vehicle, or a combination thereof.

In accordance with embodiments of the present invention, the UE and/or the further UE comprise one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a base station e.g. gNB, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or a transceiver, or any sidelink capable network entity.

In accordance with embodiments of the present invention, a network entity comprises one or more of the following: a macro cell base station, or a small cell base station, or a central unit of a base station, or a distributed unit of a base station, or a road side unit (RSU), or a UE, or a group leader (GL), or a relay or a remote radio head, or an AMF, or an SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 10 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### REFERENCES

[1] 3GPP, Study on new radio access technology: Radio access architecture and interfaces, TR 38.801, version 14.0.0, (Release 14)
[2] 3GPP, NG-RAN; F1 application protocol (F1AP), TS 38.473 version 16.3.0, (Release 16)
[3] NEC, IAB backhaul RLF handling, R2-1909659, RAN2 #107, August 2019
[4] Lenovo, Motorola Mobility, RLF notification to downstream IAB node, R2-1915129, RAN2 #108, November 2019
[5] Lenovo, Motorola Mobility, Cell selection for IAB RLF recovery, R2-1915128, RAN2 #108, November 2019
[6] ZTE, Sanechips, Discussion on IAB BH RLF handling, R2-1915119, RAN2 #108, November 2019
[7] Intel Corporation, Further discussion on Backhaul RLF handling, R2-2000472, RAN2 #109, March 2020
[8] Samsung, Remaining issues on IAB RLF, R2-2001633, RAN2 #109, March 2020
[9] NEC, Discussion on IAB BH RLF handling, R2-1914975, RAN2 #108, November 2019
[10] ZTE, Sanechips, Discussion on IAB BH RLF handling, R2-2002855, RAN2 #109bis-e, April 2020
[11] Kyocera, Possible issues on Backhaul RLF handling, R2-2003314, RAN2 #109bis-e, April 2020
[12] 3GPP, 5G; NR; Radio Resource Control (RRC); Protocol specification, TS 38.331 version 16.1.0 (Release 16)
[13] 3GPP, NG-RAN; NR user plane protocol, TS 38.425, Version 16.0.0 (Release 16)
[14] 3GPP, Automatic Neighbour Relation (ANR) management; Concepts and requirements, 3GPP TS 32.511 V16.0.0 (Release 16)
[15] 3GPP, Universal Terrestrial Radio Access (UTRA), Evolved Universal Terrestrial Radio Access (E-UTRA) and Next Generation Radio Access; Radio measurement collection for Minimization of Drive Tests (MDT); Overall description; Stage 2, TS 37.320 Version 16.0.0 (Release 16)
[16] Technical Specification Group Services and System Aspects; Procedures for the 5G System; Stage 2, 3GPP TS 23.502 V15.0.0 (Release 15)

1. A network node configured for operating in a wireless communication network,
wherein the network node is configured or pre-configured with configuration instructions or to receive configuration instructions, the configuration instructions related to an action that causes the network node to disconnect from the wireless communication network;
wherein the network node is to receive, from the wireless communication network, a trigger signal comprising information to perform the action; and
performing the action based on the trigger signal,
wherein the action further relates to one or more of
a reconnection action to reconnect to the wireless communication network,
a deregister action, e.g., access barring;
an initiation of a cell-search;
a normal handover;
a conditional handover, CHO.

2. The network node of claim 1, wherein the network node is configured or pre-configured with a conditional handover, CHO, configuration as the action, which is triggerable by the wireless communication network.

3. The network node of claim 1, wherein the network node is configured or pre-configured with a conditional handover, CHO, configuration as the action, which is exclusively triggerable by the wireless communication network.

4. The network node of claim 3, wherein the conditional handover, CHO, configuration is configured in a firmware of the network node or hard-coded.

5. The network node of claim 1, wherein the network node is configured, pre-configured or to receive expiration information associated with the configuration instructions and indicating an expiration of the configuration instructions to operate according to the trigger signal only before the expiration of the configuration instructions.

6. The network node of claim 1, wherein the network node is configured for receiving a configuration signal comprising the configuration instructions and the trigger signal together as an execution signal, e.g., a single message, and/or as separate messages.

7. The network node of claim 1, wherein the network node is configured for receiving the configuration instructions during a first instance of time and for preparing the action; and for receiving the trigger signal during a later, second instance of time.

8. The network node of claim 7, wherein the network node is configured for
performing the action directly after having received the trigger signal; or
performing the action with a predefined delay after having received the trigger signal; or
performing the action based on an execution and/or time preference of the network node after having received the trigger signal, e.g., in accordance with the configuration instructions; or
performing the action based on a further trigger condition and/or a further status within the network node.

9. The network node of claim 1, wherein the configuration instructions indicate a designated access node or group of access nodes of the wireless communication network to which the network node is requested to connect, wherein the network node is configured for connecting to the designated access node when performing the action.

10. The network node of claim 1, wherein the configuration instructions indicate a plurality of designated access nodes of the wireless communication network to which the network node is requested to connect, the plurality being ordered in an ordered list, wherein the network node is to select a new access node from the ordered list based on side information.

11. The network node of claim 1, wherein the network node is configured for performing the action exclusively responsive to the trigger signal.

12. The network node of claim 1, wherein the network node is configured for performing the action based on the trigger signal and/or based on at least one additional event; wherein the network node is configured for performing the action based on having determined that the at least one event has occurred.

13. The network node of claim 1, wherein the network node is configured for performing the action, the action comprising to connect to a designated access node indicated in the configuration instructions, the designated access node comprising a metric relating to a channel quality, a link quality and/or a link capability being lower when compared to a different access node being reachable for the network node.

14. The network node of claim 1, wherein the configuration instructions comprise a plurality of actions; wherein, responsive to the trigger signal, the network node is to select and perform one of the plurality of actions.

15. The network node of claim 1, wherein the configuration instructions indicate a plurality of access nodes, e.g., as a plurality of configurations or preconfigurations for a conditional handover, to which the network node may connect; wherein, responsive to the trigger signal, the network node is to select at least one of the plurality of access nodes as selected access node and to connect to the selected access node.

16. The network node of claim 1, wherein the network node is to receive the trigger signal while being in an RRC_IDLE state being associated with a first access node and for changing the association to a second access node in accordance with the configuration instructions responsive to the trigger signal; or
wherein the network node is to receive the trigger signal while being in an RRC_INACTIVE state and for connecting to an access node in accordance with the configuration instructions when changing to an RRC_CONNECTED state.

17. The network node of claim 1, wherein the network node is or comprises one or more of:
a user equipment, UE;
a group lead UE;
a relay node;
a road side unit, RSU,
an integrated access and backhaul, IAB, node

18. An access node configured for operating in a wireless communication network, the access node configured for providing a connection or proxy-access for a network node of the wireless communication network, the access node configured for:
transmitting a trigger signal, to a network node, the trigger signal comprising information indicating that the network node is requested to perform an action that causes the network node to disconnect from the wireless communication network and for which the network node is configured or pre-configured;
wherein the action relates to one or more of
a reconnection action to reconnect to the wireless communication network,
a deregister action, e.g., access barring;
an initiation of a cell-search;
a normal handover;
a conditional handover, CHO.

19. The access node of claim 18, wherein the access node is to provide the proxy-access for a network node; wherein the access node is to operate by use of a first identifier associated with the access node; wherein the access node is to receive a signal comprising information to request the access node to operate by use of a second identifier associated with a different access node so as to operate as a proxy for connections of the different access node.

20. A wireless communication network, comprising:
at least one network node of claim 1; and
at least one access node of claim 18.
